(19) United States
(12) Patent Application Publication
(10) Pub. No.: US 2026/0094223 A1
(43) Pub. Date: Apr. 2, 2026

(54) SYSTEM AND METHOD FOR CONTINUOUSLY ADAPTING CONTENT ON AN EDUCATION PLATFORM

(71) Applicant: Masson AI LLC, Windermere, FL (US)

(72) Inventor: Kyle A. Masson, Windermere, FL (US)

(21) Appl. No.: 19/335,470

(22) Filed: Sep. 22, 2025

Related U.S. Application Data
(60) Provisional application No. 63/702,263, filed on Oct. 2, 2024.

(51) Int. Cl. G06Q 50/20; G06N 3/098; G06Q 10/0639

(52) U.S. Cl. CPC G06Q 50/2057; G06N 3/098; G06Q 10/06398

(57) ABSTRACT

A system for continuously adapting a content on an education platform is described. The system includes a plurality of user devices, a personalization server communicatively coupled to the plurality of user devices, and an optimization server communicatively coupled to the personalization server. Each user device is configured to obtain data associated with a corresponding user. The personalization server creates learning pathways for each user. The optimization server generates content associated one or more education disciplines based on the learning pathways. The personalization server further determines performance data and interaction data based on the content and adapts the learning pathways based on the performance data and the interaction data. The optimization server receives the adapted learning pathways and updates the content based on the adapted learning pathways.

### CROSS-REFERENCE TO RELATED APPLICATIONS

The present application claims priority under 35 U.S.C. § 119(e) to U.S. Provisional Ser. No. 63/702,263 , titled System and Method for Blockchain-Based Autonomous Education System filed Oct. 2, 2024, the disclosure of which is herein incorporated by reference in its entirety.

### BACKGROUND OF THE INVENTION

Education is vital for societal progress, fostering innovation, critical thinking, and personal growth. The traditional education system is a structured approach centered around formal institutions and standardized assessments focusing on knowledge and skill development. However, the traditional standardized curriculum does not adequately address the diverse learning needs and preferences of individual students. This one-size-fits-all approach can hinder the educational development of students. Another significant challenge in the traditional education system is inequitable access to resources, resulting in unequal opportunities for students.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates an exemplary system for continuously adapting a content on an education platform, in accordance with some embodiments;

FIG. 2 illustrates a block diagram of an exemplary user device for use within the system of FIG. 1, in accordance with some embodiments;

FIG. 3 illustrates a block diagram of an exemplary personalization server for use within the system of FIG. 1, in accordance with some embodiments;

FIG. 4 illustrates a block diagram of an exemplary optimization server for use within the system of FIG. 1, in accordance with some embodiments;

FIG. 5 illustrates a block diagram of an exemplary storage server for use within the system of FIG. 1, in accordance with some embodiments;

FIGS. 6A and 6b illustrate an exemplary method for continuously adapting the content on the education platform, in accordance with some embodiments; and FIG. 7 is a process map for continuously adapting the content on the education platform, in accordance with some embodiments.

Skilled artisans will appreciate that elements in the figures are illustrated for simplicity and clarity and have not necessarily been drawn to scale. For example, the dimensions of some of the elements in the figures can be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the description with details that will be readily apparent to those of ordinary skill in the art having the benefit of the description herein.

### DETAILED DESCRIPTION OF THE INVENTION

In one aspect, a system for continuously adapting a content on an education platform is described. The system includes a plurality of user devices, a personalization server communicatively coupled to the plurality of user devices, and an optimization server communicatively coupled to the personalization server. Each user device is configured to obtain data associated with a corresponding user. The data includes personal data and education data of the corresponding user. The personalization server includes a plurality of artificial intelligence modules correspondingly associated with the plurality of user devices. Each artificial intelligence module is configured to obtain the personal data and the education data associated with the corresponding user from the corresponding user device and create a personalized learning profile for the corresponding user based on the personal data and the education data. The personalized learning profile includes data associated with one or more of learning capabilities, learning disabilities, education preferences, and preferred learning techniques of the corresponding user. Each artificial intelligence module is further configured to create learning pathways for the corresponding user based on the personalized learning profile. The learning pathways include details associated with at least one of: a complexity, a format, and a presentation of the content to be presented on the corresponding user device. The optimization server includes a plurality of artificial intelligent agent teacher modules correspondingly associated with a plurality of education disciplines. Each artificial intelligent agent teacher module is configured to receive the learning pathways associated with the corresponding user of each user device from the corresponding artificial intelligence module and generate the content associated with the corresponding education discipline correspondingly for each user device based on the received learning pathways. Each artificial intelligence module is further configured to determine performance data and interaction data associated with the corresponding user based on the content presented on the corresponding user device in real-time and adapt learning pathways for the corresponding user based on the performance data and the interaction data of the corresponding user with the content presented on the corresponding user device. The adaptation of the learning pathways includes adjustments to the at least one of: the complexity, the format, and the presentation of the content to be presented on the corresponding user device. Each artificial intelligence module is further configured to repeat determination of the performance data and the interaction data, and the adaptation of the learning pathways for the corresponding user when new performance data and interaction data is determined and anonymize and transmit the personal data, the education data, the interaction data, and the performance data of the corresponding user for storage to a storage server. Each artificial intelligent agent teacher module is further configured to receive the adapted learning pathways associated with the corresponding user of each user device from the corresponding artificial intelligence module and update the content associated with the corresponding education discipline correspondingly for each user device based on the received adapted learning pathways. Furthermore, each artificial intelligent agent teacher module is further configured to continuously retrieve and analyze the personal data, the education data, the interaction data, and the performance data associated with the plurality of user devices stored in the storage server to refine one or more grading algorithms, assessments, and teaching methods and continuously adapt the content to be presented correspondingly on each user device based on the refined one or more grading algorithms, assessments, and teaching methods.

In another aspect, a method for continuously adapting a content on an education platform is described. The method includes obtaining, by each user device of a plurality of user devices, data associated with a corresponding user. The data includes personal data and education data of the corresponding user. The method further includes obtaining, by each artificial intelligence module of a plurality of artificial intelligence modules of a personalization server, the personal data and the education data associated with the corresponding user from the corresponding user device. Further, the method includes creating, by each artificial intelligence module, a personalized learning profile for the corresponding user based on the personal data and the education data. The personalized learning profile includes data associated with one or more of learning capabilities, learning disabilities, education preferences, preferred learning techniques of the corresponding user. The method further includes creating, by each artificial intelligence module, learning pathways for the corresponding user based on the personalized learning profile and receiving, by each artificial intelligent agent teacher module of a plurality of artificial intelligent agent teacher modules of an optimization server, the learning pathways associated with the corresponding user of each user device from the corresponding artificial intelligence module. The learning pathways include details associated with at least one of: a complexity, a format, and a presentation of the content to be presented on the corresponding user device. Further, the method includes generating, by each artificial intelligent agent teacher module, the content associated with the corresponding education discipline correspondingly for each user device based on the received learning pathways and determining, by each artificial intelligence module, performance data and interaction data associated with the corresponding user based on the content presented on the corresponding user device in real-time. The method further includes adapting, by each artificial intelligence module, learning pathways for the corresponding user based on the performance data and the interaction data of the corresponding user with the content presented on the corresponding user device. The adaptation of the learning pathways includes adjustments to the at least one of: the complexity, the format, and the presentation of the content to be presented on the corresponding user device. Furthermore, the method includes repeating, by each artificial intelligence module, determination of the performance data and the interaction data, and the adaptation of the learning pathways for the corresponding user when new performance data and interaction data is determined and anonymizing and transmitting, by artificial intelligence module, the personal data, the education data, the interaction data, and the performance data of the corresponding user for storage to a storage server. The method further includes receiving, by each artificial intelligent agent teacher module, the adapted learning pathways associated with the corresponding user of each user device from the corresponding artificial intelligence module and updating, by each artificial intelligent agent teacher module, the content associated with the corresponding education discipline correspondingly for each user device based on the received adapted learning pathways. The method further includes continuously retrieving and analyzing, by each artificial intelligent agent teacher module, the personal data, the education data, the interaction data, and the performance data associated with the plurality of user devices stored in the storage server to refine one or more grading algorithms, assessments, and teaching methods and continuously adapting, by each artificial intelligent agent teacher module, the content to be presented correspondingly on each user device based on the refined one or more grading algorithms, assessments, and teaching methods.

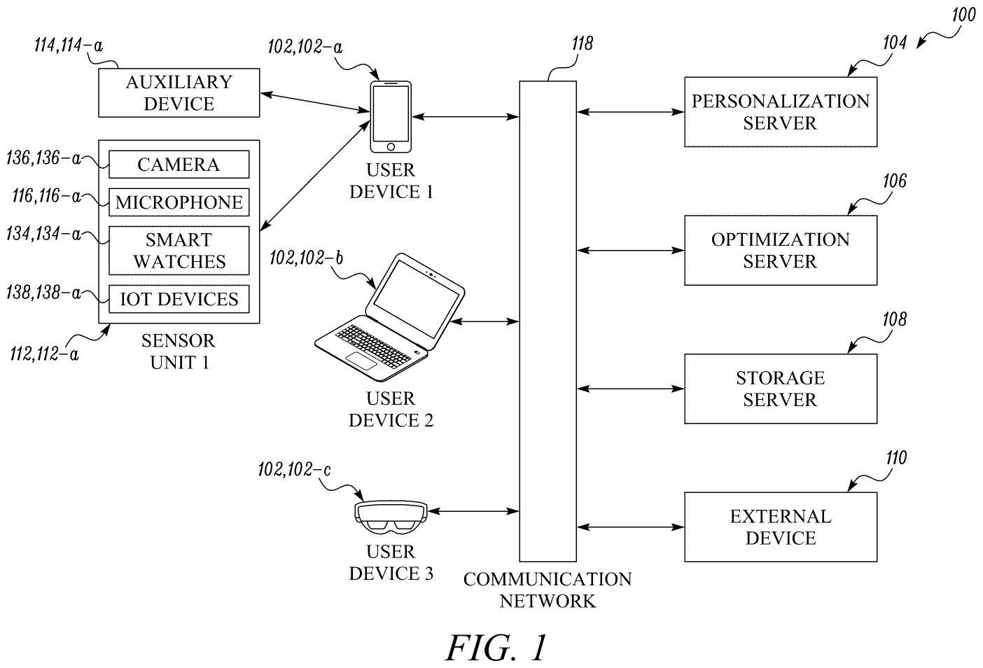

Referring to FIG. 1, an exemplary system 100 for continuously adapting a content on an education platform is illustrated. The education platform corresponds to a digital platform or portal that allows users (interchangeably referred to as students and/or learners) to access content, learn new skills, and track their progress. In some embodiments, the education platform is also utilized by teachers to teach new skills to the students and track their progress. The content refers to teaching material associated with various educational and/or vocational disciplines. The content is presented in various formats including, but not limited to, courses, modules, videos, tools, games, interactive exercises, assessments, or any material designed to educate the students. The education platform organizes, delivers, manages, and updates this content to facilitate effective learning experiences for the students. In accordance with various embodiments, the system 100 is configured to continuously adapt the content on the educational platform based on personal data, education data, performance data, and interaction data (also referred to as comprehensive student data) of each user, as described in detail in the forthcoming description. In some embodiments, the system 100 is also configured to continuously adapt the content on the educational platform based on changes in educational standards and regulations of a curriculum associated with the content.

In accordance with various embodiments, the personal data corresponds to any information identifying the user. For example, the personal data includes age, gender, region, language, and any other information for identifying the corresponding user now known or developed in the future. The education data corresponds to any information related to the student's course, learning preferences, learning objectives, career objectives, past learning activities, and any other information required for various educational and/or vocational teaching of the student. For example, the education data includes vocational data, educational background, learning background, historical scores, historical grades, historical transcripts, curriculum, class identifiers (that are self-selected by the user, approved by a parent or guardian, or automatically assigned by an institutional authority, such as, a school district, higher-education registrar, corporate-training learning management system, or apprenticeship program), trainings, qualification, professional experience, learning experience, instructional background, projects completed, and any other information required for the educational and/or vocational teaching of the student now known or developed in the future. The performance data corresponds to any information related to performance metrics of the student. For example, the performance data includes test scores, skill assessment tests, quiz attempts, badges earned, leaderboard scores, quiz answers, project submissions, and other real-time assessment data of the student now known or developed in the future. The interaction data corresponds to data generated from user interactions with the content presented on the education platform displayed on the user device 102. For example, the interaction data includes one or more of facial expressions, voice, tone, physiological data and any behavioral data associated with the user interactions now known or developed in the future. The interaction data includes biometric or physiological indicators of stress, fatigue, or emotional state for the corresponding user. For example, the interaction data includes heart rate, micro-expressions, galvanic skin responses for stress and fatigue detection, self-reported moods, brief reflection surveys, blood pressure, respiratory rate, eye-tracking, skin temperature, brain activity, Electrocardiogram activity, Electroencephalogram activity, Electromyography activity, ambient light, noise level, temperature, motion data, haptic feedback, or any other behavioral data. In some embodiments, the interaction data also includes the engagement data such as, session durations, login frequencies, time spent on specific lessons, navigation patterns, and gamification data (for example, points earned, badges, achievements, streaks or any other gamification data now known or in the future developed).

The system 100 includes at least one user device 102 (for example, but not limited to, user devices 102-a, 102-b, 102-c), a personalization server 104, an optimization server 106, a storage server 108, and an external device 110. The at least one user device 102, the personalization server 104, the optimization server 106, the storage server 108, and the external device 110 are communicatively coupled to each other via a communication network 118 (referred also interchangeably as network 118). The network 118 is a secure network including, but not limited to, a Local Area Network (LAN), a Wireless Local Area Network (WLAN), a Wireless Personal Area Network (WPAN) including, but not limited to, Bluetooth®, a Small Area Network (SAN), and a telecommunication network including, but not limited to, a fourth generation (4G) and a fifth generation (5G) cellular network employing any of a variety of communications protocols as is now known or in the future developed.

In some embodiments, to ensure continuity in bandwidth-constrained or intermittent-connectivity settings, a plurality of edge-nodes (not shown), either micro-servers in school routers or the user device 102, hosts a replicated cache of data to be communicated over the communication network 118. For example, the data includes, but is not limited to, one or more of: recently accessed fragments of the content, delta updates to one or more artificial intelligence models (described in detail later), performance data, and interaction data. In such cases, each node employs opportunistic epidemic-synchronization protocols to reconcile with the storage server 108 when connectivity is restored without any data loss.

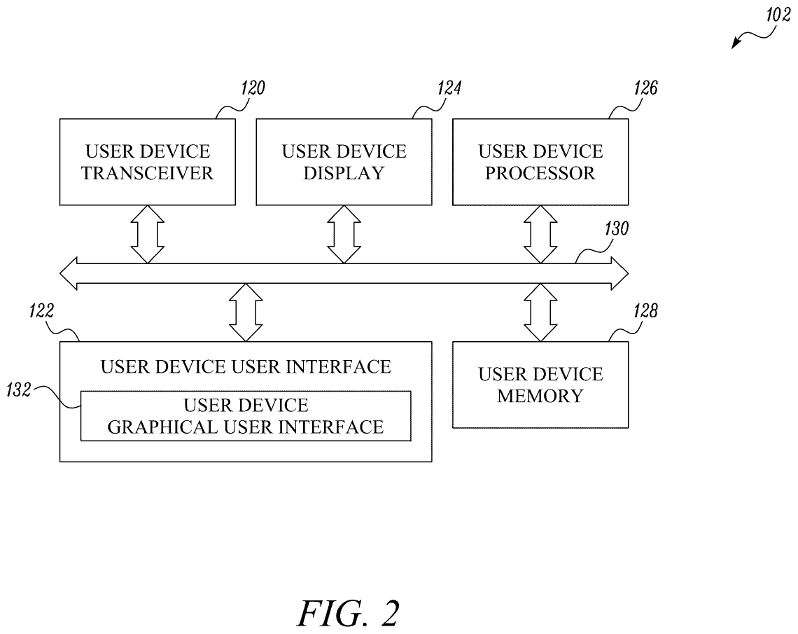

Each user device 102 operates as a user interface for the corresponding user, for example, to enable the student to access the education platform. Each user device 102 is configured to obtain data (such as, the personal data, the education data, the performance data, and the interaction data) associated with the corresponding user and display the content that is personalized (hereinafter interchangeably referred to as personalized content) based on the obtained data. The user device 102 is a mobile telephone 102-a, a computer 102-b, an augmented reality device 102-c, or any other communication device now known or in the future developed. The various components of user device 102 will now be described hereinafter with respect to FIG. 2. It should be appreciated by those of ordinary skill in the art that FIG. 2 depicts the user device 102 in a simplified manner and a practical embodiment includes additional components and suitably configured logic to support known or conventional operating features that are not described in detail herein. Although the user device 102 is illustrated and described to be implemented within a single communication device, it is contemplated that the one or more components of the user device 102 are alternatively implemented in a distributed computing environment.

Referring to FIG. 2, the user device 102 includes, among other components, a user device transceiver 120, a user device user interface 122, a user device display 124, a user device processor 126, and a user device memory 128. The components of the user device 102, including the user device transceiver 120, the user device user interface 122, the user device display 124, the user device processor 126, and the user device memory 128, cooperate with one another to enable operations of the user device 102. Each component communicates with one another via a user device local interface 130. The user device local interface 130 includes, but not limited to, one or more buses or other wired or wireless connections, as is known in the art. The user device local interface 130 includes additional elements, which are omitted for simplicity, such as controllers, buffers (caches), drivers, repeaters, and receivers, among many others, to enable communications. Further, the user device local interface 130 includes address, control, and/or data connections to enable appropriate communications among the aforementioned components.

As illustrated, the user device 102 includes the user device transceiver 120 to transmit one or more inputs to and receive one or more outputs from one or more other devices, such as, (as illustrated in FIG. 1) a sensor unit 112, an auxiliary device 114, the personalization server 104, the optimization server 106, and the storage server 108. For example, the user device transceiver 120 is configured to transmit the data associated with the corresponding user to the personalization server 104 and receive the personalized content from the optimization server 106 directly or via the personalization server 104. The user device transceiver 120 includes a transmitter circuitry and a receiver circuitry to enable the user device 102 to communicate with the one or more other devices. In this regard, the transmitter circuitry includes appropriate circuitry to transmit the one or more inputs to the one or more other devices and the receiver circuitry includes appropriate circuitry to receive the one or more outputs from the one or more other devices. It will be appreciated by those of ordinary skill in the art that the user device 102 includes a single user device transceiver 120 as illustrated, or alternatively separate transmitting and receiving components, for example but not limited to, a transmitter, a transmitting antenna, a receiver, and a receiving antenna. In accordance with various embodiments, the user device transceiver 120 also includes a Bluetooth module (not illustrated) to transmit a Bluetooth® signal and establish a connection with other Bluetooth® enabled devices including, but not limited to, the sensor unit 112, the auxiliary device 114, and any other Bluetooth enabled device. It would be appreciated that the components and functionality of the Bluetooth module integrated in the user device transceiver 120 of the user device 102 is well known in the art and is not described here for the sake of brevity. In some embodiments (not illustrated), the Bluetooth module is separate from the user device transceiver 120.

In accordance with various embodiments, the user device user interface 122 is configured to receive the inputs from and/or provide the outputs to the user. The inputs are provided via a touch screen display (such as, the user device display 124 or the auxiliary device 114), a camera, a touch pad, a keyboard, a microphone, a recorder, a mouse, or any other user input mechanism integrated within or coupled to the user device 102 (such as, the sensor unit 112), now known or developed in the future. The outputs are provided via a display device (such as the user device display 124 or the auxiliary device 114), a speaker, a haptic output, or any other output mechanism integrated within or coupled to the user device 102, now known or developed in the future. The user device user interface 122 further includes a serial port, a parallel port, an infrared (IR) interface, a universal serial bus (USB) interface and/or any other interface herein known or developed in the future.

In accordance with some embodiments, the user device user interface 122 includes a user device graphical user interface (GUI) 132 through which the user communicates with the education platform. The user device GUI 132 is the application or the web portal or any other suitable interface for accessing the educational platform. The user device GUI 132 includes one or more of graphical elements including, but not limited to one or more of infographics, charts, diagrams, motion graphics, typography, dialogue boxes, window, web forms, and/or the like. The graphical elements are used in conjunction with text or numbers to prompt the user for the inputs or display the outputs to the user in response to one or more instructions from the one or more other devices.

The user device display 124 is configured to display text, numbers, infographics, charts, diagrams, motion graphics, typography, dialogue boxes, window, web forms, and other graphical elements now known or developed in future. The user device display 124 includes a display screen, a head-mounted display, or a computer monitor now known or in the future developed. In accordance with some embodiments, the user device display 124 is configured to display on the user device GUI 132 the outputs received from the one or more other devices.

The user device memory 128 is a non-transitory memory configured to store a set of instructions that are executable by the user device processor 126 to perform predetermined operations. For example, the user device memory 128 includes any of the volatile memory elements (for example, random access memory (RAM)), non-volatile memory elements (for example, read only memory (ROM)), and combinations thereof. Moreover, the user device memory 128 incorporates electronic, magnetic, optical, and/or other types of storage media. In accordance with some embodiments, the user device memory 128 is also configured to store the data associated with the user, the personalized content, and the application associated with the user device GUI 132.

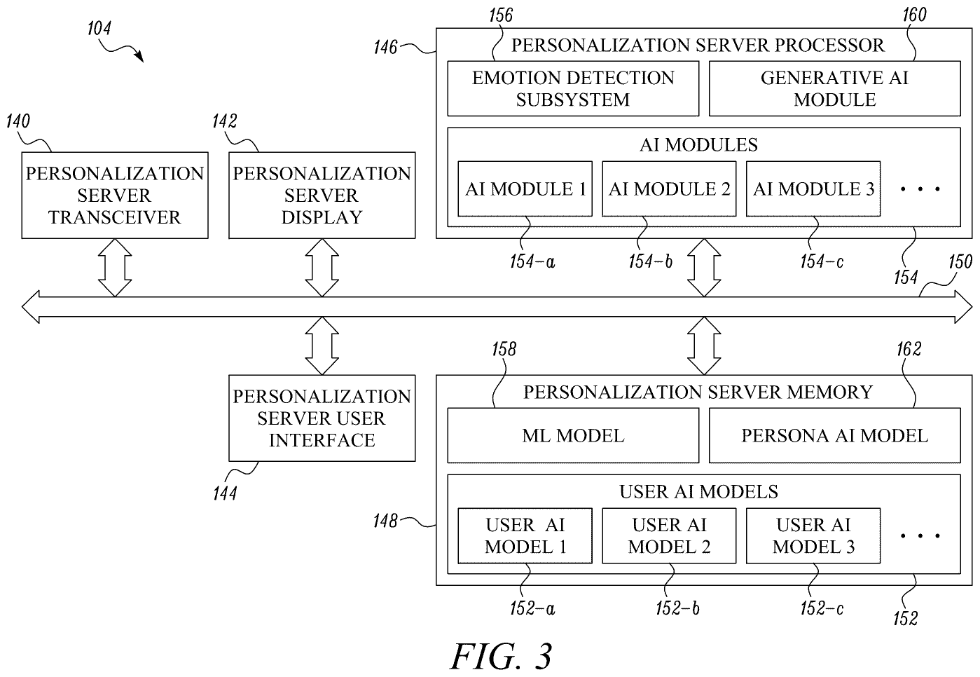

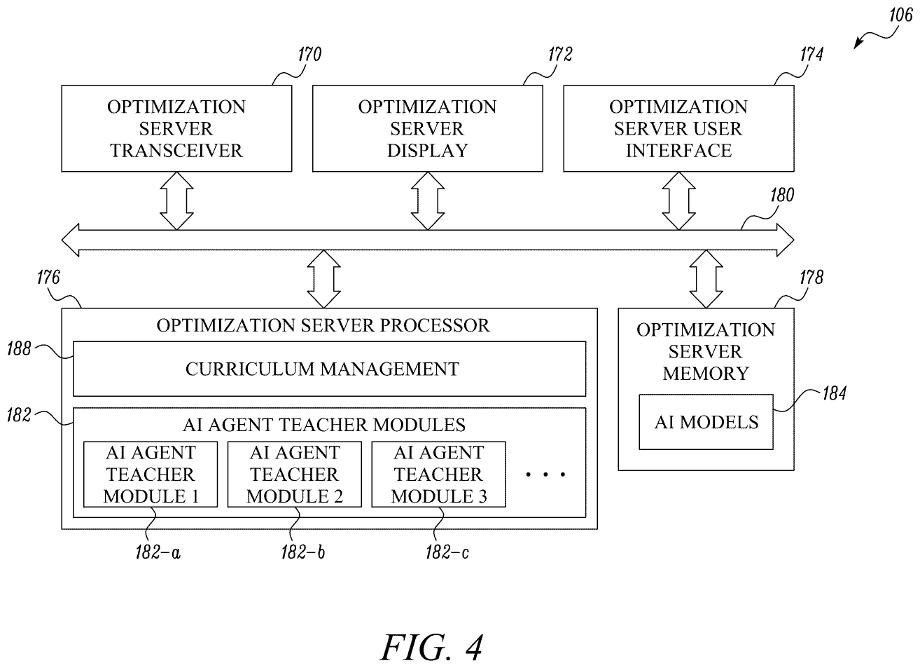

The user device processor 126 is configured to execute the instructions stored in the user device memory 128 to perform the predetermined operations. The user device processor 126 includes one or more microprocessors, microcontrollers, DSPs (digital signal processors), state machines, logic circuitry, or any other device or devices that process information or signals based on operational or programming instructions. The user device processor 126 is implemented using one or more controller technologies, such as Application Specific Integrated Circuit (ASIC), Reduced Instruction Set Computing (RISC) technology, Complex Instruction Set Computing (CISC) technology, Neural Processing Units (NPUs), Tensor Processor Unit (TPU), or any other similar technology now known or in the future developed. The user device processor 126 is configured to cooperate with other components of the user device 102 to perform operations pursuant to one or more instructions from the one or more other devices. In embodiments when one or more of artificial intelligence (AI) modules 154, user artificial intelligence (AI) models 152 (shown in FIG. 3), and an emotion detection subsystem 156 (shown in FIG. 4) are included in the user device 102, the user device processor 126 also incorporates a specialized NPU (also referred to as a “Neural Engine” or AI Accelerator) to expedite one or more machine learning tasks of the user device 102 while reducing latency and power consumption. This NPU-based architecture enhances the local-first approach to the artificial intelligence, enabling real-time adaptation and privacy safeguards without transmitting any raw personal data of the user to any device externally. In such cases, the user device 102 is configured to train the one or more local artificial intelligence models (such as, the user artificial intelligence (AI) models 152) using a user specific parameter set and transmits only anonymized gradient or delta parameters to the personalization server 104, thereby implementing a federated-learning process that preserves user privacy. The user specific parameter set includes one or more of fine-tuned model weights, delta layers, adapter layers, Low-Rank Adaptation (LoRA) adapters, personalized embeddings or other learnable parameters.

Referring back to FIG. 1, in some embodiments, each user device 102 is correspondingly coupled to a sensor unit 112. For example, as illustrated in FIG. 1, the user device 102-a is coupled to the sensor unit 112-a. Each sensor unit 112 is configured to capture the data, for example, the interaction data, of the corresponding user with the content presented on the corresponding user device. As discussed above, the interaction data corresponds to data generated from user interactions with the content presented on the education platform displayed on the user device 102. The sensor unit 112 includes, but is not limited to, one or more of a camera 136 (for example, the camera 136-a), a microphone 116 (for example, the microphone 116-a), a smartwatch 134 (for example, the smartwatch 134-a), an internet of things (IoT) device 138 (for example, the IoT device 138-a), or any other wearable or non-wearable device capable of capturing the interaction data. For example, the camera 136 is configured to obtain the facial expression and the physiological data, such as, eye-tracking of the corresponding user. The microphone 116 is configured to obtain the voice and the tone of the corresponding user. Similarly, the smartwatch 134 and the IoT device 138 include a plurality of different sensors for capturing environmental data, biometric data, and haptic data. For example, the smartwatch 134 and the IoT device 138 capture the facial expressions, the voice, the tone, and the physiological data of the corresponding user. In some embodiments, the IoT device 138 is integrated within classroom furniture or home study environments. The IoT device 138 provides posture metrics, ambient carbon dioxide (CO₂) concentration, particulate matter level, illumination level, and acoustic noise level. Additionally, each sensor unit 112 (and in some embodiments, where privacy policies permit, the microphone and the camera of the user device 102) continuously captures brief audio and video samples to distinguish indoor versus outdoor settings, recognize environmental hazards (such as heavy rain, flooding, lightning, smoke, sudden loud noises or other ambient conditions), and assess overall ambient safety. It would be appreciated by a person skilled in the art that the interaction data of a user can be captured using various devices and methods known in the art or developed in the future and is not limited to the sensor unit 112 described above. In alternate embodiments, the functionality of one or more components of the sensor unit 112 are integrated within the user device 102 to capture the interaction data of the corresponding user.

In accordance with some embodiments, the plurality of user devices 102 are correspondingly coupled to a plurality of auxiliary devices 114 to create immersive, interactive educational experiences. For example, as illustrated in FIG. 1, the user device 102-a is coupled to the auxiliary device 114-a. Each auxiliary device 114 is configured to establish a sensory engagement of the content with the corresponding user. The sensory engagement includes presenting engaging contextual overlays and simulations. For example, the sensory engagement includes visualization of abstract concepts, generation of interactive models, gamifying learning, addition of three dimensional (3D) models and animations, view exploded views, tactile stimulation, vibration, temperature control, and any other sensory engagement mechanisms known in the art or developed in future. The auxiliary device 114 includes one or more of an augmented reality device, a virtual reality device, gloves, or any wearable device capable of establishing sensory engagement of the content with the corresponding user. For example, for subjects requiring live demonstration (such as, vocational trades or laboratory sciences), the auxiliary device 114 is utilized to provide a mixed-reality telepresence session. In such cases, an expert instructor's volumetric video stream is rendered within the auxiliary device 114 and bi-directional haptic channels (for example, via a glove force-feedback or tool-mounted sensors of the auxiliary device 114 or the sensor unit 112) stream the interaction data and the performance data, for example, to the one or more other devices. For example, the augmented reality device and the virtual reality device are configured to provide the visualization of abstract concepts, the creation of interactive models, the gamifying learning experience, the addition of 3D models and animations, the exploded views of the content, and other experiences to establish the sensory engagement of the content with the user. In some embodiments, the auxiliary device 114 also works in concert with the IoT devices 138 to capture environmental-context data and biometric data in real-time. This integration enables dynamic adjustment of the educational content based on the physical context, the user's physiological data, biometric data, and the environmental-context data, thereby enhancing personalization and interactivity throughout the learning process.

Similarly, the gloves are configured to provide the tactile stimulation, the vibration, the haptic feedback, the temperature control, and other sensory feedback now known or developed in the future (such as, touch, pressure or movement) associated with the content. It would be appreciated by a person skilled in the art that establishing a sensory engagement of the content using auxiliary devices 114 is well known in the art and is not described in detail here for sake of brevity. It would be appreciated by a person skilled in the art that the sensory engagement of the content can be established using various devices and methods known in the art or developed in future and is not limited to the auxiliary device 114 described above. In alternate embodiments, one or more components of the auxiliary device 114 are integrated within the user device 102 to establish the sensory engagement. Although the auxiliary device 114 is illustrated and described to be a separate device from the user device 102, it is contemplated that one or more components of the auxiliary device 114 are alternatively implemented in a distributed computing environment in two or more computing devices.

FIG. 1 illustrates the personalization server 104 configured to create and adapt learning profile and learning pathways for each user device 102 based on the data associated with the corresponding user. The learning profile includes data associated with one or more of learning capabilities, learning disabilities, education preferences, and preferred learning techniques of the corresponding user. In some embodiments, the learning profile also integrates historical academic performance (such as test scores, transcripts, and past coursework), socio-economic background, extracurricular interests, career objectives, and real-time interaction and environmental data (captured by the sensor unit 112) of the corresponding user. The learning pathways include details associated with at least one of a complexity, a format, a presentation, an adaptive pacing schedule, a curriculum, or credential alignment of the content to be presented on the corresponding user device 102. In some embodiments, the learning pathways also indicate one or more education disciplines relevant to the corresponding user. For example, the learning pathways indicate that the user is a science student and/or the education disciplines relevant to the user are physics, chemistry, and mathematics.

As illustrated in FIG. 3, the personalization server 104 includes a plurality of electrical and electronic components, providing power, operational control, communication, and the like within the personalization server 104. For example, the personalization server 104 includes, among other components, a personalization server transceiver 140, a personalization server user interface 144, a personalization server display 142, a personalization server processor 146, and a personalization server memory 148. It should be appreciated by those of ordinary skill in the art that FIG. 3 depicts the personalization server 104 in a simplified manner and a practical embodiment includes additional components and suitably configured logic to support known or conventional operating features that are not described in detail herein. It will further be appreciated by those of ordinary skill in the art that the personalization server 104 is a personal computer, desktop computer, tablet, smartphone, or any other computing device now known or developed in the future.

Further, although the personalization server 104 is illustrated and described to be implemented within a single computing device, it is contemplated that the one or more components of the personalization server 104 are alternatively implemented in a distributed computing environment, without deviating from the scope of the claimed subject matter. It will further be appreciated by those of ordinary skill in the art that the personalization server 104 alternatively functions within a remote server, cloud computing device, or any other remote computing mechanism now known or developed in the future. In some embodiments, the personalization server 104 is a cloud environment incorporating the operations of the personalization server transceiver 140, the personalization server display 142, the personalization server user interface 144, the personalization server processor 146, and the personalization server memory 148, and various other operating modules to serve as a software as a service model for other devices, such as, the user device 102, the optimization server 106, and the storage server 108. In an embodiment, one or more of the personalization server 104, the optimization server 106, the storage server 108, the user device 102, and the external device 110 are one computing device incorporating the one or more operations of the respective components of the personalization server 104, the optimization server 106, the storage server 108, and the user device 102. In an embodiment, the functionalities of one or more of the personalization server 104, the optimization server 106, the storage server 108, the user device 102, and the external device 110 are distributed in two or more computing devices.

The components of the personalization server 104, including the personalization server transceiver 140, the personalization server display 142, the personalization server user interface 144, the personalization server processor 146, and the personalization server memory 148 communicates with one another via a personalization server local interface 150. The personalization server local interface 150 includes, namely, but not limited to, one or more buses or other wired or wireless connections, as is known in the art. The personalization server local interface 150 has additional elements, but not limited to, such as controllers, buffers (caches), drivers, repeaters, and receivers, among many others, to enable communications. Further, the personalization server local interface 150 includes address, control, and/or data connections to enable appropriate communications among the aforementioned components.

The personalization server transceiver 140 includes a transmitter circuitry and a receiver circuitry (not illustrated) to enable the personalization server 104 to communicate data to and acquire data from other devices, such as, the user device 102, the optimization server 106, and the storage server 108. In this regard, the transmitter circuitry includes appropriate circuitry to transmit data to the other devices and the receiver circuitry includes appropriate circuitry to receive the data from the other devices. The transmitter circuitry and the receiver circuitry together form a wireless transceiver to enable wireless communication with the other devices. It will be appreciated by those of ordinary skill in the art that the personalization server 104 includes a single personalization server transceiver 140 as illustrated, or alternatively separate transmitting and receiving components, for example but not limited to, a transmitter, a transmitting antenna, a receiver, and a receiving antenna.

In some embodiments, the personalization server user interface 144 is configured to receive data from and/or provide output to a user (for example, a programmer). The data is provided via a touch screen display (such as, the personalization server display 142), a camera, a touch pad, a keyboard, a microphone, a recorder, a mouse, or any other user input mechanism now known or developed in the future. The output is provided via a display device, such as the personalization server display 142, a speaker, a haptic output, or any other output mechanism now known or developed in the future. The personalization server user interface 144 further includes a serial port, a parallel port, an infrared (IR) interface, a universal serial bus (USB) interface and/or any other interface herein known or developed in the future. The personalization server display 142 includes a display screen or a computer monitor now known or in the future developed.

The personalization server processor 146 is configured to execute the instructions stored in the personalization server memory 148 to perform the predetermined operations, for example, the detailed functions of the personalization server 104 as will be described hereinafter. The personalization server processor 146 includes one or more microprocessors, microcontrollers, DSPs (digital signal processors), state machines, logic circuitry, or any other device or devices that process information or signals based on operational or programming instructions. The personalization server processor 146 is implemented using one or more controller technologies, such as Application Specific Integrated Circuit (ASIC), Reduced Instruction Set Computing (RISC) technology, Complex Instruction Set Computing (CISC) technology, Neural Processing Units (NPUs), Tensor Processor Unit (TPU), or any other similar technology now known or in the future developed. In some embodiments, the personalization server processor 146 is configured to anonymize and transmit, via the personalization server transceiver 140, the personal data, the education data, the interaction data, and the performance data of each user for storage to the storage server 108.

The personalization server processor 146 includes a plurality of artificial intelligence (AI) modules 154 (for example, 154-a, 154-b, 154-c, and so on) correspondingly associated with the plurality of user devices 102. Depending on a type of the user device 102, the personalization server 104 deploys the artificial intelligence module 154 either with a Small Language Model (SLM) for a low powered user device or a Large Language Model (LLM) for the user device with ample computational resources. The artificial intelligence module 154-a is associated with the user device 102-a, the artificial intelligence module 154-b is associated with the user device 102-b, the artificial intelligence module 154-c is associated with the user device 102-c, and so on. Each artificial intelligence module 154 is an artificial intelligence module capable of processing and understanding the data associated with its corresponding user, and creating the personalized learning profile and the learning pathways associated with the corresponding user. Each artificial intelligence module 154 is configured to learn and adapt itself to continuous improvement in changing environments. The artificial intelligence module 154 employs any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, and/or soft computing. The artificial intelligence module 154 implements an iterative learning process. The learning is based on a wide variety of learning rules or training algorithms. In an embodiment, the learning rules include one or more of back-propagation, federated learning, pattern-by-pattern learning, supervised learning, and/or interpolation. For example, the federated learning is used for training of a global artificial intelligence (AI) model (for example, but not limited to, artificial intelligence (AI) models 184 shown in FIG. 4) for improving pedagogical/teaching methods. Each artificial intelligence module 154 is configured to implement and/or executes one or more artificial intelligence algorithms to train the corresponding user artificial intelligence (AI) model 152 (for example, 152-a, 152-b, 152-c, and so on), for creating and updating the learning profile and the learning pathways for the corresponding user. For example, the artificial intelligence module 154-a is configured to train its corresponding user artificial intelligence model 152-a, for creating and updating the learning profile and the learning pathways for the corresponding user. In accordance with some embodiments of the invention, the artificial intelligence algorithm utilizes any artificial intelligence methodology, now known or in the future developed, for classification. For example, the artificial intelligence methodology utilized includes one or a combination of: Linear Classifiers (Logistic Regression, Naive Bayes Classifier); Nearest Neighbor; Support Vector Machines; Decision Trees; Boosted Trees; Random Forest; and/or Neural Networks. The artificial intelligence module 154 determines the personal data and the education data of the corresponding user and creates the personalized learning profile and the learning pathways of the corresponding user based on the personal data and the education data. The artificial intelligence module 154 continually determines the performance data and the interaction data of the corresponding user and adapts the learning pathways based on the performance data and the interaction data. The artificial intelligence intent is to continually adapt the learning pathways of a user to provide the personalized content to the user.

In accordance with various embodiments, each artificial intelligence module 154 is pretrained on a set of training data to create the personalized learning profile for a user depending upon one or more of the personal data, the education data, the performance data, and the interaction data of the user. Each artificial intelligence module 154 is configured to receive a training input data set comprising multiple sets of personal data, education data, performance data, and interaction data and a training output data set comprising personalized learning profiles corresponding to each set of the personal data, the education data, the performance data, and the interaction data provided in the training input data. Each artificial intelligence module 154 is configured to implement the artificial intelligence algorithms to train its corresponding user artificial intelligence model 152 and determine a correlation (hereinafter referred to as learning profile correlation) between the training input data set and the training output data set. Once the user artificial intelligence model 152 is trained, the corresponding artificial intelligence module 154 is configured to utilize the user artificial intelligence model 152 to create the personalized learning profile for its user based on one or more of the personal data, the education data, the performance data, and the interaction data of the user. As discussed above, each artificial intelligence module 154 is configured to learn and adapt itself upon receipt of every new personal data, education data, performance data, interaction data, and/or feedback from the user.

In accordance with various embodiments, each artificial intelligence module 154 is pretrained on a set of training data to create the personalized learning pathways for a user depending upon the personalized learning profiles of the corresponding user. Each artificial intelligence module 154 is configured to receive a training input data set comprising multiple sets of learning profiles and a training output data set comprising personalized learning pathways corresponding to each set of the learning profiles provided in the training input data. Each artificial intelligence module 154 is configured to implement the artificial intelligence algorithms to train its corresponding user artificial intelligence model 152 and determine a correlation (hereinafter referred to as learning pathways correlation) between the training input data set and the training output data set. Once the user artificial intelligence model 152 is trained, the corresponding artificial intelligence module 154 is configured to utilize the user artificial intelligence model 152 to create the personalized learning pathways for its user based on the personalized learning profile of the user. As discussed above, each artificial intelligence module 154 is configured to learn and adapt itself upon receipt of every new personalized learning profile and/or feedback from one or more of the user device 102, the auxiliary device 114 (via the user device 102), and the sensor unit 112 (via the user device 102) to adapt the learning pathways. Although not described here, a person skilled in the art would appreciate that the artificial intelligence module 154 can include either one single user artificial intelligence model 152 for determining both the personalized learning profile and the personalized learning pathways or separate user artificial intelligence models 152 for determining the personalized learning profile and the personalized learning pathways respectively.

In some embodiments, each artificial intelligence module 154 is a part of the corresponding user device 102. By operating the artificial intelligence module 154 at the user device level, the data associated with the user (for example, the personal data, the education data, the interaction data, and the performance data) remains local, secure, and under user's control. In such cases, the data of the user is anonymized before transmitting to other devices, such as, the personalization server 104 or the optimization server 106, to preserve privacy. By doing so, the system 100 employs a robust privacy-by-design architecture wherein the majority of data processing occurs locally on the user devices 102. By leveraging federated learning techniques, each user device 102 computes the updates for the corresponding user artificial intelligence model 152 based on the anonymized data. The updates are then securely aggregated to improve the global AI model for improving pedagogical/teaching methods without exposing the data of the users. Differential privacy mechanisms are further employed to ensure that even the aggregated updates cannot be used to re-identify individual users, thereby reinforcing both personalization and data security throughout the system 100.

In some embodiments, each artificial intelligence module 154 is configured to maintain, for its corresponding user device 102, an anonymous user specific parameter set comprising one or more of the fine-tuned model weights, the delta layers, the adapter layers, the Low-Rank Adaptation (LoRA) adapters, the personalized embeddings or other learnable parameters that are not shared with any other user and utilize the user specific parameter set together with a set of parameters that are common to multiple other users when generating the personalized learning profile and the learning pathways.

Although FIG. 3 illustrates the plurality of artificial intelligence modules 154 and the plurality of user artificial intelligence models 152 correspondingly associated with the plurality of user devices 102, it would be appreciated by a person skilled in the art that the personalization server 104 can include only one artificial intelligence module and one user artificial intelligence model associated with the plurality of user devices 102 (instead of the plurality of artificial intelligence modules 154 and the plurality of user artificial intelligence models 152) to perform the above-described functions.

The personalization server processor 146 includes the emotion detection subsystem 156 configured to determine an emotional state of a user based on the interaction data of the corresponding user. The emotion detection subsystem 156 employs one or more machine learning models 158 configured to learn and adapt to continuous improvement in changing environments. The emotion detection subsystem 156 employs any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, and/or soft computing. The emotion detection subsystem 156 implements an iterative learning process. The learning is based on a wide variety of learning rules or training algorithms. In an embodiment, the learning rules include one or more of back-propagation, pattern-by-pattern learning, federated learning, supervised learning, and/or interpolation. For example, the personalization server processor 146 utilizes the federated learning technique to further train the emotion detection subsystem 156 and its machine learning model 158. The emotion detection subsystem 156 is configured to implement one or more machine learning algorithms to train the machine learning models 158 to determine an emotional state of a user based on the interaction data of the user. In accordance with some embodiments of the invention, the machine learning algorithm utilizes any machine learning methodology, now known or in the future developed, for classification. For example, the machine learning methodology utilized includes one or a combination of: Linear Classifiers (Logistic Regression, Naive Bayes Classifier); Nearest Neighbor; Support Vector Machines; Decision Trees; Boosted Trees; Random Forest; and/or Neural Networks. The emotion detection subsystem 156 continually obtains the interaction data of each user from the corresponding sensor unit 112 and determines the emotional state of the user based on the obtained interaction data. It would be appreciated by a person skilled in the art that the determination of the emotional state of the user based on the interaction data of the user is well known in the art, and hence the details are not described here for the sake of brevity. In some embodiments, the emotion detection subsystem 156 and the machine learning models 158 are included in the user devices 102.

The personalization server processor 146 includes a generative artificial intelligence (AI) module 160 configured to generate a two-dimensional (2D) or three-dimensional (3D) persona to deliver the content on the corresponding user device 102 and modify interactions of the 2D or 3D persona with the corresponding user on the corresponding user device based on the emotional state of the user. In some embodiments, these 2D or 3D personas appear as subtle overlays or augmented reality projections, providing, for example, guidance, explanations, or additional examples. In some embodiments, the user devices 102 are configured to summon or minimize these 2D or personas as needed, maintaining control over how much guidance they receive. In some embodiments, the generative artificial intelligence module 160 is also configured to produce personalized digital media (such as interactive videos and game-like simulations) that align with the learner's evolving proficiency and interests.

The generative artificial intelligence module 160 is configured to learn and adapt itself to continuous improvement in changing environments. The generative artificial intelligence module 160 employs any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, soft computing, generative adversarial networks, and/or variational encoders. The generative artificial intelligence module 160 implements an iterative learning process. The learning is based on a wide variety of learning rules or training algorithms. In an embodiment, the learning rules include one or more of back-propagation, pattern-by-pattern learning, federated learning, supervised learning, and/or interpolation. The generative artificial intelligence module 160 is configured to implement one or more artificial intelligence algorithms to train persona artificial intelligence (AI) models 162 to generate the 2D or 3D persona and modify interactions of the 2D or 3D persona based on the emotional state of the user. For example, when emotional cues (stress, confusion) are detected, the interactions of the 2D or 3D persona are modified to gently suggest helpful resources, breaks, or simpler explanations. Moreover, the tone, visuals, or suggestions of the 2D or 3D persona adapt in real-time, creating a supportive and empathetic learning environment. In some embodiments (not discussed), the generative artificial intelligence module 160 is a part of the optimization server processor 176. It would be appreciated by a person skilled in the art that the generation of a 2D or 3D persona to deliver a content and modifying the interactions of the generated 2D or 3D persona based on the emotional state of the user is well known in the art and is not described here for the sake of brevity.

The personalization server memory 148 is a non-transitory memory configured to store a set of instructions that are executable by the personalization server processor 146 to perform the predetermined operations. For example, the personalization server memory 148 includes any of the volatile memory elements (for example, random access memory (RAM)), non-volatile memory elements (for example read only memory (ROM)), and combinations thereof. Moreover, the personalization server memory 148 incorporates electronic, magnetic, optical, and/or other types of storage media. In some embodiments, the personalization server memory 148 has a distributed architecture, where various components are situated remotely from one another, but are accessed by the personalization server processor 146. The software in the personalization server memory 148 includes one or more software programs, each of which includes an ordered listing of executable instructions for implementing logical functions. The personalization server memory 148 also includes the learning profile, the learning pathways, the personal data, the education data, the performance data, and the interaction data associated with each user. The personalization server memory 148 also includes the user artificial intelligence models 152 executed by the artificial intelligence modules 154, the machine learning models 158 executed by the emotion detection subsystem 156, and the persona artificial intelligence (AI) models 162 executed by the generative artificial intelligence module 160.

Referring back to FIG. 1, the optimization server 106 is configured to generate the content based on the learning pathways. As illustrated in FIG. 4, the optimization server 106 includes a plurality of electrical and electronic components, providing power, operational control, communication, and the like within the optimization server 106. For example, the optimization server 106 includes, among other components, an optimization server transceiver 170, an optimization server user interface 174, an optimization server display 172, an optimization server processor 176, and an optimization server memory 178. It should be appreciated by those of ordinary skill in the art that FIG. 4 depicts the optimization server 106 in a simplified manner and a practical embodiment includes additional components and suitably configured logic to support known or conventional operating features that are not described in detail herein. It will further be appreciated by those of ordinary skill in the art that the optimization server 106 is a personal computer, desktop computer, tablet, smartphone, or any other computing device now known or developed in the future.

Further, although the optimization server 106 is illustrated and described to be implemented within a single computing device, it is contemplated that the one or more components of the optimization server 106 are alternatively be implemented in a distributed computing environment, without deviating from the scope of the claimed subject matter. It will further be appreciated by those of ordinary skill in the art that the optimization server 106 alternatively functions within a remote server, cloud computing device, or any other remote computing mechanism now known or developed in the future. In some embodiments, the optimization server 106 is a cloud environment incorporating the operations of the optimization server transceiver 170, the optimization server display 172, the optimization server user interface 174, the optimization server processor 176, and the optimization server memory 178, and various other operating modules to serve as a software as a service model for other devices, such as, the user device 102, the personalization server 104, the storage server 108, and the external device 110.

The components of the optimization server 106, including the optimization server transceiver 170, the optimization server display 172, the optimization server user interface 174, the optimization server processor 176, and the optimization server memory 178 communicates with one another via an optimization server local interface 180. The optimization server local interface 180 includes, namely, but not limited to, one or more buses or other wired or wireless connections, as is known in the art. The optimization server local interface 180 have additional elements, but not limited to, such as controllers, buffers (caches), drivers, repeaters, and receivers, among many others, to enable communications. Further, the optimization server local interface 180 includes address, control, and/or data connections to enable appropriate communications among the aforementioned components.

The optimization server transceiver 170 includes a transmitter circuitry and a receiver circuitry (not illustrated) to enable the optimization server 106 to communicate data to and acquire data from other devices, such as, the user device 102, the personalization server 104, the storage server 108, and the external device 110. In this regard, the transmitter circuitry includes appropriate circuitry to transmit data to and the receiver circuitry includes appropriate circuitry to receive data from the other devices. The transmitter circuitry and the receiver circuitry together form a wireless transceiver to enable wireless communication with the other devices. It will be appreciated by those of ordinary skill in the art that the optimization server 106 includes a single optimization server transceiver 170 as illustrated, or alternatively separate transmitting and receiving components, for example but not limited to, a transmitter, a transmitting antenna, a receiver, and a receiving antenna.

In some embodiments, the optimization server user interface 174 is configured to receive data from and/or provide output to a user (for example, a programmer). The data is provided via a touch screen display (such as, the optimization server display 172), a camera, a touch pad, a keyboard, a microphone, a recorder, a mouse, or any other user input mechanism now known or developed in the future. The output is provided via a display device, such as the optimization server display 172, a speaker, a haptic output, or any other output mechanism now known or developed in the future. The optimization server user interface 174 further includes a serial port, a parallel port, an infrared (IR) interface, a universal serial bus (USB) interface and/or any other interface herein known or developed in the future. The optimization server display 172 includes a display screen or a computer monitor now known or in the future developed.

The optimization server processor 176 is configured to execute the instructions stored in the optimization server memory 178 to perform the predetermined operations, for example, the detailed functions of the optimization server 106 as will be described hereinafter. The optimization server processor 176 includes one or more microprocessors, microcontrollers, DSPs (digital signal processors), state machines, logic circuitry, or any other device or devices that process information or signals based on operational or programming instructions. The optimization server processor 176 are be implemented using one or more controller technologies, such as Application Specific Integrated Circuit (ASIC), Reduced Instruction Set Computing (RISC) technology, Complex Instruction Set Computing (CISC) technology, Neural Processing Units (NPUs), Tensor Processor Unit (TPU), or any other similar technology now known or in the future developed.

The optimization server processor 176 includes a plurality of artificial intelligence (AI) agent teacher modules 182 (for example, 182-a, 182-b, 182-c, and so on) correspondingly associated with a plurality of educational disciplines. The AI agent teacher modules 182 are driven by one or more Artificial Intelligence Models 184 (AI Models 184) for real-time personalization and adaptive instruction, to provide highly personalized instruction across academic and vocational training. In some embodiments, the one or more AI models 184 are located in a remote device and each AI agent teacher module 182 is configured to generate the content by accessing the one or more remote AI models using an application programming interface (API) or a communication gateway. Each AI agent teacher module 182 specializes within specific fields of study including but not limited to, for example, mathematics, science, physics, and liberal arts. For example, the AI agent teacher module 182-a is associated with liberal arts, the AI agent teacher module 182-b is associated with mathematics, and the AI agent teacher module 182-c is associated with physics. Each AI agent teacher module 182 communicates through various forms, including 3D and 2D character representations (discussed above), text, voice, and other verbal and visual methods, enhancing user engagement through immersive and interactive educational experiences tailored to individual preferences. As discussed in detail in the forthcoming disclosure, the content generated by the AI agent teacher module 182 is dynamically tailored to the learning pathways of the user (for example, the student) that is created based on the data associated with the student, while augmented reality devices and haptic devices enhance engagement of the content and skill development during presentation of the content on the user device 102. The personalized learning profile and learning pathways accommodate students with exceptional abilities and disabilities and enable the AI agent teacher module 182 provide the content through adaptive interfaces, accessible content formats, and assistive technologies, ensuring that every student can thrive.

Each AI agent teacher module 182 is configured to learn and adapt itself to continuous improvement in changing environments. The AI agent teacher module 182 employs any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, variational encoders and/or soft computing. The AI agent teacher module 182 implements an iterative learning process. The learning is based on a wide variety of learning rules or training algorithms. In an embodiment, the learning rules include one or more of back-propagation, pattern-by-pattern learning, supervised learning, and/or interpolation. Each AI agent teacher module 182 is configured to implement one or more artificial intelligence algorithms to train one or more corresponding artificial intelligence (AI) models 184 for generating the personalized content for each user device 102. In accordance with some embodiments of the invention, the artificial intelligence algorithm utilizes any artificial intelligence methodology, now known or in the future developed, for classification. For example, the artificial intelligence methodology utilized includes one or a combination of: Linear Classifiers (Logistic Regression, Naive Bayes Classifier); Nearest Neighbor; Support Vector Machines; Decision Trees; Boosted Trees; Random Forest; and/or Neural Networks. Each AI agent teacher module 182 generates and continually updates the content based on the adapted learning pathways received from the personalization server 104. Each AI agent teacher module 182 is further configured to continuously retrieve and analyze anonymized personal data, anonymized education data, anonymized interaction data, and anonymized performance data associated with the plurality of user devices 102 to refine pedagogical methods and generate culturally localized, multimodal educational materials. For example, the AI agent teacher module 182 is configured to refine one or more grading algorithms, assessments, and teaching methods. By continually refining, for example, difficulty, pace, and delivery style, the AI agent teacher modules 182 enhance each users'engagement with the content.

In some embodiments, each artificial intelligence module 154 is configured to obtain data (for example, the posture metrics, the ambient carbon dioxide (CO2) concentration, the particulate matter level, the illumination level, and the acoustic noise level) from the corresponding IoT device 138 and normalize the data into an environmental-quality score appended to the interaction data. When the score falls below a configurable comfort threshold, the AI agent teacher module 182 defers cognitively intense tasks, insert stretch-break reminders, or shift modality (e.g., from reading to audio lessons), thereby protecting learner well-being while sustaining effective engagement. In some embodiments, a dedicated Environmental-Context Engine within the AI agent teacher module 182 applies on-device audio and vision models (for example, scene-classification convolutional neural networks) to label contexts like outdoors, near moving traffic, or crowded public space. At the same time, the AI agent teacher module 182 performs real-time application programming interface (API) request to external weather sources (e.g., National Oceanic and Atmospheric Administration or OpenWeatherMap) to retrieve local forecasts, severe-weather alerts, and air-quality indices. This data from the external weather sources is fused with the on-device environmental-quality score into a unified safety-readiness index. Whenever this index falls into a predefined danger range (for example, sudden thunderstorms during a field-trip lesson or smoke alerts during an outdoor exercise), the AI Agent Teacher module 182 adapts content delivery, pacing, or safety prompts. For example, the AI agent teacher module 182 immediately pauses the lesson, prompts the learner to seek shelter indoors, switch to an audio-only module that can be followed while relocating, and even notify supervising instructors or guardians with location and alert details. By doing so, the system 100 not only sustains engagement but also actively safeguards learners in dynamic real-world environments.

In some embodiments, the AI Agent teacher module 182 and the artificial intelligence models 184 are configured on the user devices 102. In such cases, the system 100, for example, the user device 102 employs federated learning to train the global AI model for improving pedagogical methods. In this embodiment, the models are trained on user devices 102 thereby preventing sharing of any personal identifying information with any device externally. The user device 102 also employs differential privacy in sending the anonymized updates to the global AI model.

In accordance with various embodiments, each AI agent teacher module 182 is pretrained on a set of training data to modify the content for the user device 102 depending upon the learning pathways of the user. Each AI agent teacher module 182 is configured to receive a training input data set comprising multiple sets of content and learning pathways and a training output data set comprising sets of content modified based on the corresponding learning pathways. Each AI agent teacher module 182 is configured to implement the artificial intelligence algorithms to train its corresponding artificial intelligence model 184 and determine a correlation (hereinafter referred to as content correlation) between the training input data set and the training output data set. Once the artificial intelligence model 184 is trained, the corresponding AI agent teacher module 182 is configured to utilize the artificial intelligence model 184 to modify the content/data for its user based on the learning pathways of the user. For example, when the learning profile or learning pathways of a user indicates that the user suffers from a disorder with disabilities related to social interactions, sensory sensitivities, and maintaining focus and has interest in mathematics and computer programming, the artificial intelligent agent teacher modifies the content for the user such that advanced content related to the mathematics and computer programming is provided to the user with modified teaching method to address the disabilities of the user. As discussed above, each AI agent teacher module 182 is configured to learn and adapt itself upon receipt of every new data/content, learning pathways, and/or feedback from the user.

In accordance with various embodiments, each AI agent teacher module 182 is configured to continuously retrieve and analyze the personal data, the education data, the interaction data, and the performance data associated with the plurality of user devices 102 stored in the storage server 108 to refine one or more grading algorithms, assessments, and teaching methods. Each AI agent teacher module 182 is pretrained on a set of training data to refine the grading algorithms, the assessments, and the teaching methods depending upon the personal data, the education data, the interaction data, and the performance data of the plurality of users. Each AI agent teacher module 182 is configured to receive a training input data set comprising multiple sets of the personal data, the education data, the interaction data, and the performance data and a training output data set comprising the grading algorithms, the assessments, and the teaching methods corresponding to the personal data, the education data, the interaction data, and the performance data. Each AI agent teacher module 182 is configured to implement the artificial intelligence algorithms to train its corresponding artificial intelligence model 184 and determine a correlation (hereinafter referred to as grading correlation) between the training input data set and the training output data set. Once the artificial intelligence model 184 is trained, the corresponding AI agent teacher module 182 is configured to utilize the artificial intelligence model 184 to determine and refine the grading algorithms, the assessments, and the teaching methods based on the personal data, the education data, the interaction data, and the performance data of the users stored in the storage server 108.

In an embodiment, each AI agent teacher module 182 is further configured to integrate specialized sub-assistants, such as a game design assistant, a collaboration and peer-learning assistant, or an accessibility-focused assistant, to offer more granular support for learners'diverse needs and preferences. By invoking these sub-assistants on-demand, the AI agent teacher module 182 generates context-specific mini-games, group activities, or personalized learning materials that are automatically adapted to each learner's emotional state, device form factor, and real-time performance data. Moreover, for users requiring enhanced accessibility support, the AI agent teacher module 182 further comprises an accessibility assistant sub-module configured to deliver the content through assistive features such as text-to-speech, large-print interfaces, haptic feedback, or sign-language overlays based on the user device 102 capabilities, the inputs from the sensor unit 112, or the personal data of the user (e.g., color blindness or hearing impairment). In some embodiments, the AI agent teacher module 182 orchestrates robotics or physical demonstrations by connecting to the IoT devices 138 or robotics modules (not shown), enabling real-world lab experiments, vocational simulations, physical experiments, or home-based augmented reality setups synchronized with the content and transmitting resulting sensor data or feedback to the personalization server 104 for use as an additional performance data and an additional interaction data. When operating in offline or low-bandwidth conditions, the AI agent teacher module 182 relies on locally cached content and locally running AI modules to maintain continuity of instruction. Upon reconnection, it securely synchronizes updates with other devices in the system 100, ensuring minimal data loss or disruption to the user's learning progress.

For example, the AI agent teacher modules 182 include one or more dedicated AI agent teacher assistants (not illustrated) for game design, collaborations, assessment, and content curation. In accordance with various embodiments, these AI agent teacher assistants run locally or via secure cloud-based microservices. For example, the AI agent teacher assistant includes an artificial intelligent game design assistant that enhances the curriculum by automatically generating or adapting engaging mini-games, puzzles, or immersive simulations that align with the corresponding learning pathways, thereby fostering higher motivation and interactivity through fun, personalized game-like activities. The artificial intelligent game design assistant adjusts at least one of (a) game difficulty and (b) reward logic in real time based on the performance data or the emotional state of the corresponding user. For example, the artificial intelligent game design assistant builds game levels or scenarios that adapt to real-time user's performance and emotional states, produces or modifies scenes on demand, and awards points, badges, or achievements while ensuring alignment with the reward logic of the AI agent teacher module 182 configured to assign rewards (such as, adding new features) to the users based on the performance data of the user.

In some embodiments, the artificial intelligent agent teacher assistant includes an artificial intelligent collaboration and peer learning assistant (not illustrated) that facilitates group projects, peer review, and social learning activities, thereby building collaborative skills, encouraging social-emotional development, and reducing overhead in managing group tasks. For example, the artificial intelligent collaboration and peer learning assistant pairs or clusters learners based on compatible skills, schedules, or language preferences, arranges peer reviews while respecting user privacy, generating rubrics or prompts that guide constructive critique, and detects inactivity or friction within group work, nudging participants or notifying educators if issues persist.

In some embodiments, the AI agent teacher modules 182 further integrate with an AI Agent Administrator module (not shown) to ensure policy-compliant resource management, data governance, and transparent auditing of any sub-assistant or AI-driven interventions. This cooperative framework allows the AI agent teacher module 182 to provide personalized experiences while remaining aligned with institutional policies, local regulations, and ethical AI standards. For instance, the AI Agent Administrator notifies the AI agent teacher module 182 when a newly detected policy rule constrains certain types of game content or mandates additional exam-proctoring measures. Upon receiving these notifications, the AI agent teacher module 182 adapts lesson flows and sub-assistant outputs accordingly, ensuring that all generated content remains within prescribed guidelines. This design fosters a robust, flexible ecosystem where each learner's needs are balanced against system-wide governance requirements, creating a sustainable, scalable approach to personalized education.

The optimization server processor 176 includes a curriculum management module 188 configured to dynamically update the content associated with a curriculum based on changes in educational standards and regulations of the curriculum. The detailed functionalities and operations of the optimization server processor 176 including the AI agent teacher module 182 and the curriculum management module 188 will be described hereinafter in greater detail.

The optimization server memory 178 is a non-transitory memory configured to store a set of instructions that are executable by the optimization server processor 176 to perform the predetermined operations. For example, the optimization server memory 178 includes any of the volatile memory elements (for example, random access memory (RAM)), non-volatile memory elements (for example read only memory (ROM)), and combinations thereof. Moreover, the optimization server memory 178 incorporates electronic, magnetic, optical, and/or other types of storage media. In some embodiments, the optimization server memory 178 has a distributed architecture, where various components are situated remotely from one another, but are accessed by the optimization server processor 176. The software in the optimization server memory 178 includes one or more software programs, each of which includes an ordered listing of executable instructions for implementing logical functions. The optimization server memory 178 is configured to store the learning pathways associated with each user, the content associated with each educational discipline, and the educational standards and regulations of various curricula. The optimization server memory 178 includes the artificial intelligence models 184 executed by the AI agent teacher modules 182.

Referring back to FIG. 1, the storage server 108 is configured to securely store the anonymized data (such as, the anonymized personal data, the anonymized education data, the anonymized interaction data, and the anonymized performance data) for each of the plurality of user devices 102, associate the anonymized data for each user with a designated identity, and provide the corresponding user with control permissions associated with the designated identity.

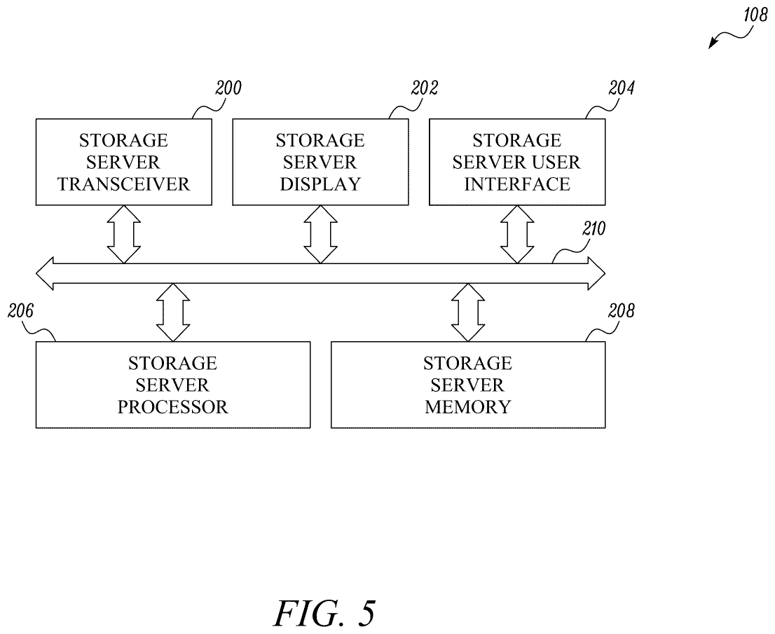

As illustrated in FIG. 5, the storage server 108 includes a plurality of electrical and electronic components, providing power, operational control, communication, and the like within the storage server 108. For example, the storage server 108 includes, among other components, a storage server transceiver 200, a storage server user interface 204, a storage server display 202, a storage server processor 206, and a storage server memory 208. It should be appreciated by those of ordinary skill in the art that FIG. 5 depicts the storage server 108 in a simplified manner and a practical embodiment includes additional components and suitably configured logic to support known or conventional operating features that are not described in detail herein. It will further be appreciated by those of ordinary skill in the art that the storage server 108 is a personal computer, desktop computer, tablet, smartphone, or any other computing and storage device now known or developed in the future.

Further, although the storage server 108 is illustrated and described to be implemented within a single computing and storage device, it is contemplated that the one or more components of the storage server 108 are alternatively be implemented in a distributed computing environment, without deviating from the scope of the claimed subject matter. It will further be appreciated by those of ordinary skill in the art that the storage server 108 alternatively functions within a remote server, cloud computing device, or any other remote computing mechanism now known or developed in the future. The storage server 108 is a cloud environment incorporating the operations of the storage server transceiver 200, the storage server display 202, the storage server user interface 204, the storage server processor 206, and the storage server memory 208, and various other operating modules to serve as a software as a service model for the user device 102, the personalization server 104, and the optimization server 106.

The components of the storage server 108, including the storage server transceiver 200, the storage server display 202, the storage server user interface 204, the storage server processor 206, and the storage server memory 208 communicates with one another via a storage server local interface 210. The storage server local interface 210 includes, namely, but not limited to, one or more buses or other wired or wireless connections, as is known in the art. The storage server local interface 210 have additional elements, but not limited to, such as controllers, buffers (caches), drivers, repeaters, and receivers, among many others, to enable communications. Further, the storage server local interface 210 includes address, control, and/or data connections to enable appropriate communication among the aforementioned components.

The storage server transceiver 200 includes a transmitter circuitry and a receiver circuitry (not illustrated) to enable the storage server 108 to communicate data to and acquire data from other devices, such as, the personalization server 104 and the optimization server 106. In this regard, the transmitter circuitry includes appropriate circuitry to transmit data to the other devices and the receiver circuitry includes appropriate circuitry to receive the data from the other devices. The transmitter circuitry and the receiver circuitry together form a wireless transceiver to enable wireless communication with the other devices. It will be appreciated by those of ordinary skill in the art that the storage server 108 includes a single storage server transceiver 200 as illustrated, or alternatively separate transmitting and receiving components, for example but not limited to, a transmitter, a transmitting antenna, a receiver, and a receiving antenna.

In some embodiments, the storage server user interface 204 is configured to receive data from and/or provide output to a user (for example, a programmer). The data is provided via a touch screen display (such as, the storage server display 202), a camera, a touch pad, a keyboard, a microphone, a recorder, a mouse, or any other user input mechanism now known or developed in the future. The output is provided via a display device, such as the storage server display 202, a speaker, a haptic output, or any other output mechanism now known or developed in the future. The storage server user interface 204 further includes a serial port, a parallel port, an infrared (IR) interface, a universal serial bus (USB) interface and/or any other interface herein known or developed in the future. The storage server display 202 includes a display screen or a computer monitor now known or in the future developed.

The storage server memory 208 is a non-transitory memory configured to store a set of instructions that are executable by the storage server processor 206 to perform the predetermined operations. For example, the storage server memory 208 includes any of the volatile memory elements (for example, random access memory (RAM)), non-volatile memory elements (for example read only memory (ROM)), and combinations thereof. Moreover, the storage server memory 208 incorporates electronic, magnetic, optical, and/or other types of storage media. In some embodiments, the storage server memory 208 has a distributed architecture, where various components are situated remotely from one another, but are accessed by the storage server processor 206. The software in the storage server memory 208 includes one or more software programs, each of which includes an ordered listing of executable instructions for implementing logical functions.

In some embodiments, the storage server memory 208 is integrated with a centralized and/or decentralized blockchain ledger for secure credentialing, data integrity, and decentralized funding mechanisms. In some embodiments, the storage server memory 208 includes its own centralized ledger containing identities and private legal information. In order to verify the identities of the students/legal representatives, the storage server processor 206 connects to a trusted government system to confirm the identity. Once the identity is verified, the storage server processor 206 creates a unique digital identification (for example, a decentralized digital identifier (DID)) for the user. The DID is controlled by the user to link to records or metrics on a separate decentralized ledger. The storage server processor 206 verifies the identity of the user through the centralized ledger. By having a verified identity on the centralized ledger and an anonymized identity on the decentralized ledger, external education leaderboards can be allowed access to the records without revealing identity or private student information. The users (for example, the students) and their legal representatives and guardians gain greater control over their educational records and the data, supported by rigorous privacy, security, and compliance measures. Such automated administrative functions, for example but not limited to, credential issuance, record-keeping, and compliance reporting, streamline operations and reduce overhead, while transparent governance and ethical AI practices guide the decision-making and maintain user trust by utilizing the blockchain ledger that securely store the anonymized data for each of the plurality of user devices 102. The blockchain ledger is a decentralized ledger that facilitates recording of the anonymized data. The blockchain ledger utilizes a chain-like structure while compiling the anonymized data, forming a chain of blocks, with each block containing one or more records associated with the anonymized data. The blockchain ledger is further configured to secure and verify the records and supports both centralized and decentralized digital identity models. The blockchain ledger is configured to be accessed by funding entities to foster user engagement and equitable resource allocation to the users.

To verify and store academic credentials securely, the storage server 108 includes a blockchain-based credential management module that supports centralized and decentralized digital identifiers (DIDs) and smart contracts. The blockchain-based credential management module enables the users to enjoy self-sovereign control of their certifications, transcripts, and achievements, which is independently verified by third parties while remaining tamper-proof and globally portable. In some embodiments, the storage server 108 also includes a student transcript module (not illustrated) that integrates with the existing AI models, ML models, curriculum, and blockchain ledger to generate, manage, verify, and customize transcripts reflecting each student's academic and vocational achievements.

The storage server processor 206 is configured to execute the instructions stored in the storage server memory 208 to perform the predetermined operations, for example, the detailed functions of the storage server 108 as will be described hereinafter. The storage server processor 206 includes one or more microprocessors, microcontrollers, DSPs (digital signal processors), state machines, logic circuitry, or any other device or devices that process information or signals based on operational or programming instructions. The storage server processor 206 are be implemented using one or more controller technologies, such as Application Specific Integrated Circuit (ASIC), Reduced Instruction Set Computing (RISC) technology, Complex Instruction Set Computing (CISC) technology, Neural Processing Units (NPUs), Tensor Processor Unit (TPU), or any other similar technology now known or in the future developed.

The storage server processor 206 is configured to securely store the anonymized data for each of the plurality of user devices 102 in the storage server memory 208, associate the anonymized data for each user with a designated identity, and provide the corresponding user with control permissions associated with the designated identity. When the storage server memory 208 corresponds to the blockchain ledger, the storage server processor 206 is configured to receive, via the storage server transceiver 200, a record associated with the anonymized data of a user and create a block that represents the received record. The storage server processor 206 is further configured to add the block to the blockchain ledger. The block of the blockchain ledger stores a record associated with the anonymized data of the user. The user according to his preference chooses centralized or decentralized blockchain ledger, where the centralized blockchain ledger is managed by a single authority (e.g. a government entity or a private consortium) and all the data is stored at a single location. The decentralized blockchain ledger forms a database of records spread across a series of nodes or computer to store the data. The anonymized user data gets converted into a unique string characters called as hash for storage in a block to ensure data integrity and immutability. A designated identity is a unique identifier assigned to the user or entity (like username or digital id) to identify the user. The permissions are controlled by a public key and a private key, where the public key is shared with everyone so that the data to be sent is encrypted, but to ensure secure transactions private key is owned only by the user to decrypt the transactions/data. The private storage contains user specific credentials, DID documents, and enrollment data.

Referring back to FIG. 1, the external device 110 is configured to store one or more large language models (LLMs) associated with one or more education disciplines. Each LLM is a large deep learning model pretrained on a large amount of data associated with one or more educational disciplines. The external device 110 is configured to provide the LLM access to the optimization server 106. The external device 110 is a personal computer, desktop computer, tablet, smartphone, a database or any other device for storing the one or more large language models now known or developed in the future. It would be appreciated by a person skilled in the art that the LLM can be any LLM known in the art capable of generating data associated with one or more educational disciplines and hence, the details of the LLM are not provided here for the sake of brevity.

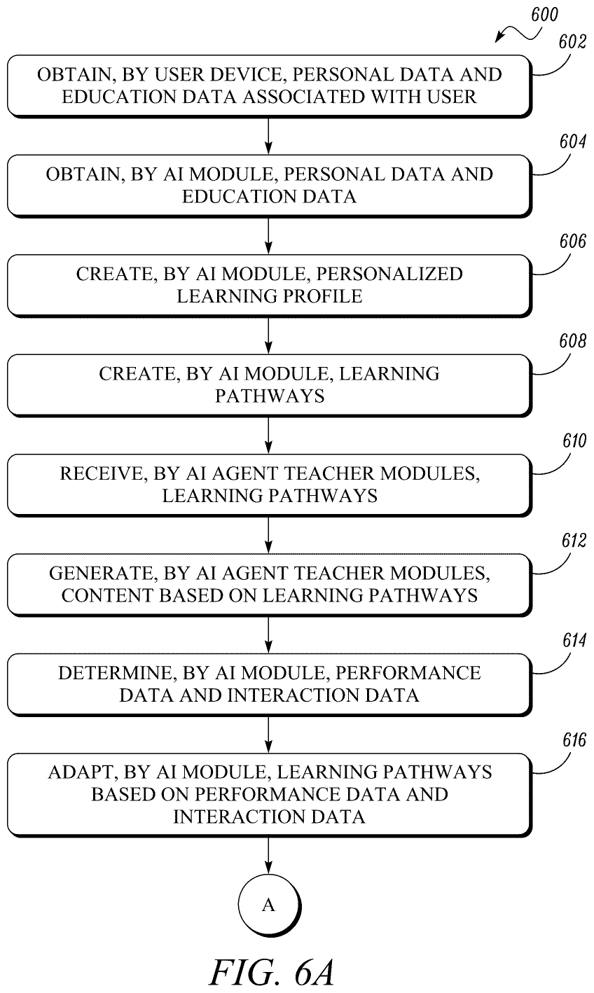

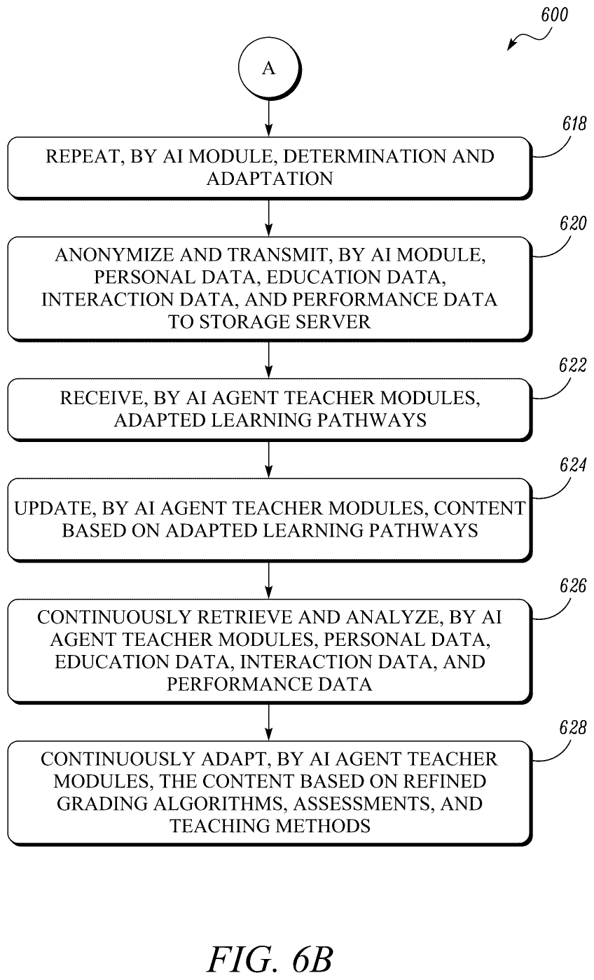

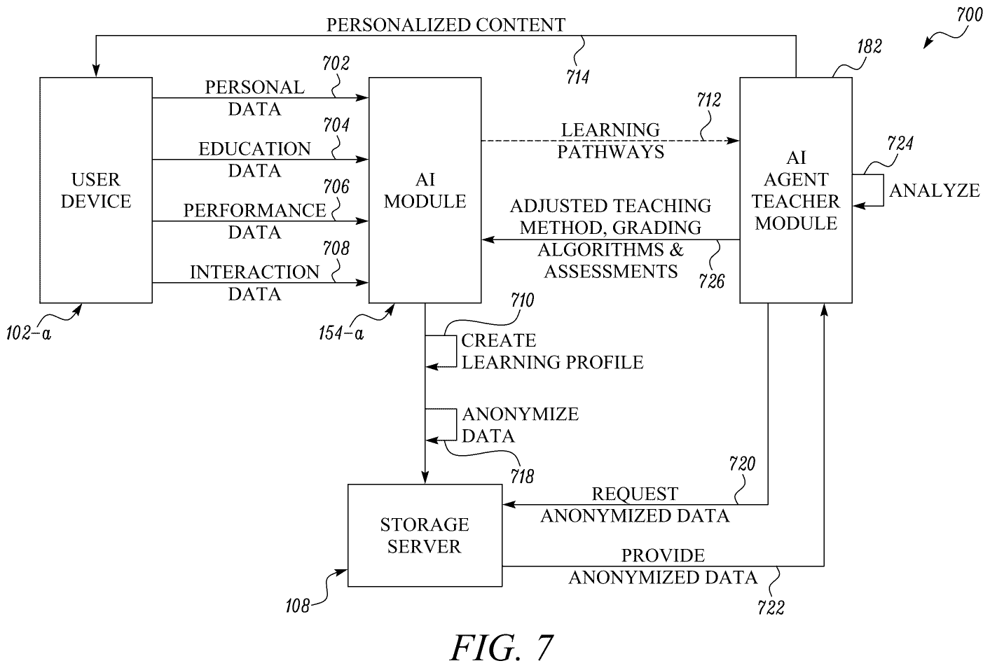

Referring to FIG. 6, an exemplary method for continuously adapting the content on the education platform is discussed. The method 600 begins, at 602, with each user device 102, obtaining data associated with the corresponding user. As discussed above, the data includes the personal data and the education data of the corresponding user. The user device 102 displays the user device GUI 132 on the user device user interface 122, for example, when the corresponding user accesses the user device GUI 132 or upon receiving an instruction from the personalization server 104. The user device 102 then receives the personal data and the education data from the corresponding user, via the user device GUI 132. For example, the user device GUI 132 displays a form or one or more prompts on the user device 102 to enable the corresponding user to enter the personal data and the education data via the user device user interface 122 or any other user input mechanism integrated within or coupled to the user device 102 (such as, the sensor unit 112).

In some embodiments, the user device 102 is configured to utilize computer vision (including optical character recognition and natural language processing techniques), to analyze user's submissions for any personally identifiable information (PII). The user's submissions include text documents, music, audio recordings, images, and video. The user device 102 uses advanced artificial intelligence techniques to reconstruct submitted content by preserving educational material, layout, and structure while omitting or replacing detected PII with non-identifiable placeholders. This ensures that any data transmitted from the user device 102 is free of sensitive information. In such cases, the PII remains securely stored in the user device 102.

It would be appreciated that although the description below describes the method 600 with respect to one user device 102-a and its associated artificial intelligence module 154-a of the personalization server 104, the method is applicable to all the user devices 102 (for example, 102-b, 102-c, and so on) and the artificial intelligence modules 154 (for example, 154-b, 154-c, and so on) without deviating from the scope of the present disclosure.

At 604, the artificial intelligence module 154-a of the personalization server 104 obtains the personal data and the education data associated with the corresponding user from the user device 102-a. The user device 102-a, upon receiving the personal data and the education data, transmits the received personal data and education data to the personalization server 104, via the user device transceiver 120. The personalization server 104, upon receiving the personal data and the education data from the user device 102-a, provides its access to the corresponding artificial intelligence module 154-a of the personalization server processor 146. For example, FIG. 7 illustrates a process map 700 in which the user device 102-a transmits the personal data 702 and the education data 704 to the artificial intelligence module 154-a.

At 606, the artificial intelligence module 154-a creates the personalized learning profile for the corresponding user based on the personal data and the education data. As discussed above, the personalized learning profile includes data associated with one or more of learning capabilities, learning disabilities, education preferences, preferred learning techniques of the corresponding user. The artificial intelligence module 154-a utilizes its corresponding user artificial intelligence model 152-a to process and understand the personal data and the education data and create the personalized learning profile based on the determined learning profile correlation. For example, FIG. 7 illustrates the artificial intelligence module 154-a creating the personalized learning profile 710.

At 608, each artificial intelligence module 154 creates or generates the learning pathways (interchangeably referred to as personalized learning pathways) for the corresponding user based on the personalized learning profile. As discussed above, the learning pathways include details associated with at least one of a complexity, a format, a presentation, an adaptive pacing schedule, or a curriculum of the content to be presented on the corresponding user device 102. In some embodiments, the learning pathways also indicate one or more education disciplines relevant to the corresponding user. For example, the learning pathways indicate that the user is a science student and/or the education disciplines relevant to the user are physics, chemistry, and mathematics. The artificial intelligence module 154-a utilizes its corresponding user artificial intelligence model 152-a to process and understand the personalized learning profile and create/generate the learning pathways based on the determined learning pathways correlation. In some embodiments, when the user (for example, the student) chooses his/her courses, the corresponding learning pathways are manually created and stored in a storage method. In such cases, the artificial intelligence module 154, through the education data and the personal data, adjusts the learning pathways.

The learning pathways are delivered to each AI agent teacher module 182 through a suite of complementary mechanisms designed for robustness, low latency, and policy compliance. In some embodiments, the AI agent teacher module 182 performs a direct read from persistent storage or a dedicated vector database, pulling the most recent learning pathway whenever the content generation begins. In event-driven configurations, updates to learning pathways trigger an immediate push to subscribed modules, ensuring that adaptations take effect in real time. Alternatively, the AI agent teacher module 182 issues on-demand API queries, either synchronously during planning phases or asynchronously in background threads, to fetch the latest learning pathway data. In some embodiments, to support edge-first or intermittent-connectivity scenarios, each the AI agent teacher module 182 recalls learning pathway snapshots from a local cache, which periodically reconciles with the central store via epidemic-style synchronization of delta updates or encrypted gradients. In privacy-preserving federated architectures, only anonymized parameter deltas or gradient summaries are exchanged, allowing each AI agent teacher module 182 to reconstruct an up-to-date learning pathway without ever transmitting raw personal data. Finally, when a learner's assignment derives from an institution- or guardian-defined curriculum rather than a bespoke profile, the AI agent teacher module 182 retrieves a canonical pathway from the Curriculum Management Module 188, either as a starting template or fallback, before applying any per-user adaptations. Collectively, these access modes for example, direct read, push notification, API pull, cache recall, federated synchronization, and curriculum-management lookup, ensure that every AI agent teacher module 182 receives the right learning pathways at the right time, in accordance with its performance, connectivity, and privacy requirements.

At 610, each AI agent teacher module 182 of the optimization server 106 receives the learning pathways associated with the corresponding user of the user device 102-a from the corresponding artificial intelligence module 154-a. The personalization server 104 transmits the learning pathways associated with the user device 102-a to the optimization server 106, via the personalization server transceiver 140. The optimization server 106, upon receiving the learning pathways, provides its access to each of the plurality of AI agent teacher module 182 of the optimization server processor 176. For example, FIG. 7 illustrates the artificial intelligence module 154-a transmitting the learning pathways 712 to the AI agent teacher modules 182.

At 612, each AI agent teacher module 182 generates the content associated with its education discipline for the user device 102-a based on the received learning pathways. For example, the AI agent teacher module 182-a generates the content associated with liberal arts, the AI agent teacher module 182-b generates the content associated with mathematics, and the AI agent teacher module 182-c generates the content associated with physics. In some embodiments, the optimization server 106 identifies the AI agent teacher modules 182 that are to be selected for generation of the content based on the learning pathways of the user. For example, when the learning pathways indicate that the user is a science student and/or the education disciplines relevant to the user are physics, chemistry, and mathematics, the optimization server 106 selects the AI agent teacher modules 182 associated with physics, chemistry, and mathematics for generating the content based on the received learning pathways. Each AI agent teacher module 182 (or the selected AI agent teacher module 182) generates the content by obtaining, via one or more application programming interface (API), data associated with the corresponding education disciplines from the LLMs stored in the external device 110 and modifying the obtained data based on the learning associated with the corresponding user to generate the content personalized for the user. In an exemplary embodiment, the AI agent teacher module 182-c associated with physics, queries the LLMs via the API, for example, to obtain the data associated with the Newton's law of motion from the LLMs. The LLMs, upon receiving the query, generate the data associated with the Newton's law of motion and transmits it to the AI agent teacher module 182-c via one or more transceivers of the external device 110. It would be appreciated by a person skilled in the art that such LLMs for generating content/data associated with various educational disciplines are well known in the art and hence, the detailed functionality of these LLM is not described here for the sake of brevity. The AI agent teacher module 182-c upon obtaining the data, modifies the obtained data based on the learning pathways associated with the user device 102-a using the determined content correlation. For example, the AI agent teacher module 182-c simplifies the complexity of the obtained data based on the learning pathways associated with the user device 102-a. In some embodiments, the AI agent teacher module 182 also modifies the content based on the data associated with the region and language of the corresponding user.

In some embodiments, the curriculum management module 188 of the optimization server 106 dynamically updates the content associated with a curriculum based on changes in educational standards and regulations of the curriculum. The curriculum management module 188 regularly receives the data associated with the educational standards and regulations of various curricula from one or more external sources (not illustrated) and determine any change in the educational standards and regulations of the curricula. In some embodiments, a distinct artificial intelligence module for each major curriculum (for example, International Baccalaureate (IB) mathematics versus Florida-based math standards) is configured. The user enrolled in multiple curricula benefit from a tailored artificial intelligence module handling each curriculum segment. When the curriculum management module 188 determines that there is a change in the educational standards and regulations, the curriculum management module 188 dynamically updates the content associated with the curriculum based on the changes. For example, a user undertaking a research project for his graduate thesis as revolutionizing cancer treatment through advanced methodology, receives the resources required for the curricula so that he can independently design, test and refine blood-based nanobots. In such cases, the curriculum management module 188 ensures that the learning materials and research methodologies are continuously updated according to the changes in educational standards and regulations of the curriculum to reflect the latest scientific advancements.

In some embodiments, the curriculum management module 188 resolves an active Jurisdiction Identification (ID) based on verified region, institutional override, or guardian selection and filters or augments content seeds so every generated lesson, assessment, or credential aligns with the governing standard. The jurisdiction ID references an authority table of national, state, or international frameworks (e.g., United Nations Educational, Scientific and Cultural Organization-International Standard Classification of Education, UNESCO ISCED, IB®, Cambridge IGCSE®) and (b) an associated Curriculum Code. When multiple frameworks apply, the curriculum management module 188 enforces a configurable policy (intersection, union, or precedence).

Upon generation of the content, the optimization server 106 transmits, via the optimization server transceiver 170, the generated content to the user device 102-a directly or via the personalization server 104 for displaying the content on the user device GUI 132. The user device 102-a, upon receiving the content, displays the content on its user device GUI 132. In some embodiments, the optimization server processor 176 or the personalization server processor 146 also generates the 2D or 3D persona to deliver the content on the user device 102-a. In some embodiments, the auxiliary device 114-a coupled to the user device 102-a is utilized to establish a sensory engagement of the content with the corresponding user. For example, FIG. 7 illustrates the AI agent teacher modules 182 transmitting the personalized content 714 to the user device 102-a.

Upon displaying the content on the user device GUI 132 of the user device 102-a, the artificial intelligence module 154-a of the personalization server 104 determines the performance data and the interaction data associated with the corresponding user based on the content in real-time. The personalization server 104 communicates with the user device 102-a to determine the performance data and the interaction data. In an exemplary embodiment, the content presented on the user device GUI 132 includes tests, quizzes, and other content for determining the performance data. In such cases, the user device 102-a obtains responses to the tests and quizzes, via the user device GUI 132, and provides the responses to the personalization server 104. The artificial intelligence module 154-a then determines the performance data (for example, the scores) based on the responses received from the user device 102-a.

In some embodiments, the user device 102-a utilizes its sensor unit 112-a to capture the interaction data of the corresponding user with the content presented on the user device 102-a. For example, the camera 136-a obtains the facial expression and the physiological data, such as, eye-tracking of the corresponding user. The microphone 116-a obtains the voice and the tone of the corresponding user. Similarly, the smartwatch 134-a and the IoT device 138-a capture the facial expressions, the voice, the tone, and the physiological data of the corresponding user. The user device 102-a then transmits the interaction data to the artificial intelligence module 154-a of the personalization server 104. For example, FIG. 7 illustrates the user device 102-a transmitting the interaction data 708 and the performance data 706 to the artificial intelligence module 154-a.

In some embodiments, the personalization server 104 further includes the emotion detection subsystem 156 determine the emotional state of the corresponding user based on the interaction data. As discussed above, the determination of the emotional state of the user based on the interaction data of the user is well known in the art, and hence the details are not described here for the sake of brevity. In an exemplary embodiment, the generative artificial intelligence module 160 modifies the interactions of the 2D or 3D persona with the corresponding user on the user device 102-a based on the emotional state of the user.

At 616, the artificial intelligence module 154-a adapts the learning pathways for the corresponding user based on the performance data and the interaction data (including the emotional state) of the corresponding user with the content presented on the corresponding user device 102-a. In accordance with various embodiments, adapting the learning pathways includes adjustments to the at least one of the complexity, the format, the presentation, the adaptive pacing schedule, or the curriculum, of the content to be presented on the corresponding user device 102. In some embodiments, the adaptation of the learning pathways is based on at least one of scheduling constraints of the corresponding user device 102 and the environmental-context data representative of one or more of lighting, noise, or other ambient conditions obtained via the user device 102 or the sensor unit 112, together with external environmental factors (such as local weather forecasts, air-quality indices, and severe-weather alerts) retrieved via an application programming interface (API) from external sources. The scheduling constraints defines an availability of the student based on, for example, the calendar information of the student. The artificial intelligence module 154-a utilizes its corresponding user artificial intelligence model 152-a to process and understand the performance data and the interaction data and create an updated personalized learning profile based on the determined learning profile correlation. Upon creating the updated personalized learning profile, the artificial intelligence module 154-a utilizes its corresponding user artificial intelligence model 152-a to create the adapted learning pathways based on the updated personalized learning profile using the determined learning pathways correlation. At 618, the artificial intelligence module 154-a repeats determination of the performance data and the interaction data, and the adaptation of the learning pathways for the corresponding user when new performance data and interaction data is determined.

At 620, the artificial intelligence module 154-a anonymizes and transmits the personal data, the education data, the interaction data, and the performance data of the corresponding user for storage to the storage server 108. The artificial intelligence module 154-a utilizes techniques such as data masking, to replace personal information associated with the user with fictional values or codes. The artificial intelligence module 154-a then transmits the anonymized personal data, the anonymized education data, the anonymized interaction data, and the anonymized performance data associated with the user of the user device 102-a to the storage server 108. For example, FIG. 7 illustrates the artificial intelligence module 154-a transmitting the anonymized data 718 to the storage server 108.

In accordance with various embodiments, the storage server 108 securely stores the anonymized personal data, the anonymized education data, the anonymized interaction data, and the anonymized performance data for each of the plurality of user devices 102, associates the anonymized personal data, the anonymized education data, the anonymized interaction data, and the anonymized performance data for each user with a designated identity, and provides the corresponding user with control permissions associated with the designated identity.

In some embodiments, the personalization server 104 is further configured to receive, in real time or periodically, the anonymized personal data, the anonymized education data, the anonymized interaction data, and the anonymized performance data from the storage server 108 and adapt the learning pathways based on the anonymized personal data, the anonymized education data, the anonymized interaction data, and the anonymized performance data.

The personalization server 104 then transmits the updates to the learning pathways or the adapted learning pathways to the optimization server 106. In accordance with various embodiments, the optimization server 106 is configured to receive updates to the learning pathways or the adapted learning pathways to continuously adapt the content and refine the one or more grading algorithms, assessments, and teaching methods. The optimization server 106 generates the updated content for the user device 102-a based on the adapted learning pathways, using the method described above. At 622, each AI agent teacher module 182 receives the adapted learning pathways associated with the corresponding user of the user device 102-a from the corresponding artificial intelligence module 154-a. At 624, each AI agent teacher module 182 updates the content associated with the corresponding education discipline for the user device 102-a based on the received adapted learning pathways. For example, each AI agent teacher module 182 generates the updated content by obtaining data associated with the corresponding education disciplines from the LLMs and modifies the obtained data based on the adapted learning pathways to generate the updated content personalized for the user.

At 626, each AI agent teacher module 182 continuously retrieves and analyzes the personal data, the education data, the interaction data, and the performance data associated with the plurality of user devices 102 stored in the storage server 108 to refine one or more of the grading algorithms, the assessments, and the teaching methods. For example, FIG. 7 illustrates the AI agent teacher modules 182 requesting 720 the anonymized data from the storage server 108 and the storage server 108 providing 722 the anonymized data to the AI agent teacher modules 182.

At 628, each AI agent teacher module 182 continuously adapts the content to be presented correspondingly on each user device 102 based on the refined one or more grading algorithms, assessments, and teaching methods. For example, FIG. 7 illustrates the AI agent teacher modules 182 analyzing 724 the anonymized data of the plurality of user devices 102 from the storage server 108 and adjusting 726 the grading algorithms, assessments, and teaching methods.

In an exemplary embodiment, one or more components of the system 100 are embedded within a robotic device, for example, an autonomous vehicle, where the vehicle's onboard sensors (for example, steering, pedals, cameras, lidar), and haptic actuators function as the user device 102 and the sensor unit 112. The artificial intelligence module 154 monitors real-time telematics and video streams as the interaction data, assesses driver actions against a department of motor vehicles (DMV) approved performance rubric, delivers coaching prompts via audio, head-up display, or haptic feedback, and grades exercises (e.g., parallel parking, lane changes). The artificial intelligence module 154 then generates the learning pathways and provides it to the AI agent teacher module 182 to generate merging drills or intersection practices and trigger the issuance of a certified driving credential.

Existing education system frequently relies on standardized curricula that assume uniform learning needs, interests, and abilities, often failing to accommodate the full spectrum of student diversity. This results in many learners (for example, those requiring specialized instruction, alternative pacing, vocational training, or accommodations for disabilities and exceptional abilities, struggling to thrive in conventional educational settings. As a consequence, students who do not fit neatly into the standard framework may find their capabilities underdeveloped and their potential unrealized.

Efforts to leverage online platforms have not yet resolved these challenges. Many digital systems offer limited personalization, providing only generic content without adapting to individual learning styles, preferences, or skill levels. These platforms often lack robust vocational training support, leaving a substantial gap for learners seeking practical, hands-on education. At the same time, insufficient accessibility features hinder students with disabilities or exceptional abilities from fully engaging with available resources, perpetuating unequal educational opportunities.

Administrative processes also pose significant barriers to educational efficiency. Manual tasks related to record-keeping, grading, compliance reporting, and credential management consume valuable time and resources. Integrating external services and handling sensitive data raise concerns about security, privacy, and consistent enforcement of data protection standards. Financial limitations further restrict access to quality education, especially for learners requiring specialized accommodations or economic support. Without decentralized funding mechanisms, community-driven financial assistance, scholarships, and grants remain out of reach for many, reinforcing inequalities in educational access.

The technologies such as artificial intelligence, blockchain, virtual and augmented reality (XR (Extended Reality)), the Internet of Things (IoT), haptic feedback, and 3D character generation are employed to overcome some of these issues. Yet, harnessing these tools within a single, cohesive platform to support personalized learning, immersive experiences, secure data management, and streamlined operations remains an unrealized goal. Additionally, as AI takes on a larger role in education, concerns about fairness, transparency, and accountability highlight the importance of establishing ethical guidelines and oversight.

Ensuring that educational content aligns with the diverse curriculum standards across regions introduces another layer of complexity. Effective solutions must adapt learning materials to meet varying standards while preserving quality and consistency. Finally, students and their legal representatives currently have limited control over their educational records. They require secure, verifiable credentials and the ability to manage personal data independently. Without such control, trust and agency are diminished.

All of these challenges underscore the urgent need for a fully integrated, autonomous, and secure educational system. Such a system would leverage advanced technologies to deliver personalized, accessible, and ethically guided learning experiences. It would streamline administrative tasks, ensure privacy and security, incorporate decentralized funding models, support vocational and academic growth, and respect local curricula. By doing so, it would provide a more inclusive, engaging, and equitable educational environment for learners worldwide.

The system and method of the present disclosure provide an autonomous digital education system that delivers personalized, adaptive, and secure instructional experiences. More specifically, the system and method of the present disclosure encompass a stand-alone platform that integrates advanced artificial intelligence (including, but not limited to, large language models and specialized small language models and artificial intelligence models), blockchain-based credential management and identity (supporting both centralized and decentralized implementations), augmented reality devices for immersive learning, Internet of Things (IoT) for environmental and biometric feedback, haptic feedback and gamification for enhanced engagement. The system is designed for both academic and vocational education, enabling a continuous, individualized learning journey from early education to professional development while ensuring robust data privacy and ethical AI governance.

In contrast to conventional e-learning platforms that offer only static course content or limited personalization features, the system and method of the present disclosure leverage artificial intelligence models to optimize real-time instruction, adjust lesson difficulty, and adapt content delivery according to each learner's academic progress, emotional state, and contextual feedback. Additionally, augmented reality devices and IoT devices enable immersive, hands-on lessons, personalizing the entire educational environment and injecting real-time interactions, both physical (via sensors, or wearables) and digital (via augmented or virtual content). Furthermore, the AI agent teacher modules 182 manage curriculum alignment, continuous assessment, data anonymization, automated grading, and user engagement strategies such as gamification, thereby providing is a comprehensive learning ecosystem that delivers a high-caliber, personalized education across all levels (academic, vocational, or professional) while respecting global privacy regulations and ethical AI principles.

It would be appreciated by persons skilled in the art that the references to “the personalization server 104,” “the optimization server 106,” “the storage server 108,” or any other computing device are intended to describe functional components of the system 100 that may be co-located or distributed. In certain embodiments, these functionalities are implemented within a single standalone computing environment or container-based platform, while in other embodiments they can be hosted on separate machines or in a distributed cloud architecture. Furthermore, the usage of the term “server” should not be construed to limit the invention to a particular hardware arrangement; in some embodiments, it refers generally to logic or software (and supporting hardware resources) that perform the personalization, content-generation, or other functions described above.

In the hereinbefore specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that can cause any benefit, advantage, or solution to occur or become more pronounced are not to be construed as a critical, required, or essential feature or elements of any or all the claims. The invention is defined solely by the appended claims including any amendments made during the pendency of this application and all equivalents of those claims as issued.

Moreover, in this document, relational terms such as first and second, top and bottom, and the like are used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but includes other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but also be configured in ways that are not listed.

It will be appreciated that some embodiments are comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Throughout the drawings, the artificial intelligence module 154 designates processor-executable logic blocks, such as firmware routines, micro-service workers, or on-device neural-processing instructions, that carry out model-execution functions including forward inference, back-propagation, few-step fine-tuning, adapter-layer insertion, retrieval-augmented generation (RAG) memory lookups, and automated rollback checks. The user artificial intelligence model 152 denotes the mutable machine-learning artefacts upon which those logic blocks operate, namely learner-specific parameter tensors, LoRA/ZoRA or other low-rank adaptation matrices, delta-weight or Feature-wise Linear Modulation (FiLM) style residual layers, personalized embedding vectors, or semantically equivalent data structures that persist on the device yet are continuously updated by the artificial intelligence module 154. In hybrid edge/cloud deployments, artificial intelligence module 154 may perform real-time personalization locally on the device's NPU, injecting and adapting only the small adapter artefacts (for example, user artificial intelligence model 152) into the frozen backbone, while a learner memory retrieval sub-module issues embeddings-based lookups into a local or cloud vector store and incorporates retrieved passages into RAG prompts. Periodically, only the modified adapter tensors (for example, the user artificial intelligence model 152), optionally quantized and infused with calibrated differential-privacy noise, along with anonymized retrieval-cache metadata are serialized and transmitted to the personalization server 104 for secure federated averaging and large-scale checkpoint optimization. The shared backbone remains immutable: switching contexts between learners, rolling back to a prior personalization, or deleting user-specific adjustments is effected simply by loading, hot-swapping, or removing the corresponding adapter file (for example, the user artificial intelligence model 152) without altering a structure of the global AI model. Continuous monitoring of on-device performance, fairness, and retrieval-hit metrics can trigger automated rollback or hot-swap to a validated checkpoint, ensuring rapid responsiveness, robust governance, and end-to-end privacy under a fully modular hybrid architecture.

Moreover, an embodiment can be implemented as a computer-readable storage medium having computer readable code stored thereon for programming a computer (example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

1. A system for continuously adapting a content on an education platform, the system comprising:
a plurality of user devices, wherein each user device is configured to:
obtain data associated with a corresponding user, wherein the data includes personal data and education data of the corresponding user;
a personalization server communicatively coupled to the plurality of user devices, the personalization server including:
a plurality of artificial intelligence modules correspondingly associated with the plurality of user devices, wherein each artificial intelligence module is configured to:
obtain the personal data and the education data associated with the corresponding user from the corresponding user device;
create a personalized learning profile for the corresponding user based on the personal data and the education data, wherein the personalized learning profile includes data associated with one or more of learning capabilities, learning disabilities, education preferences, preferred learning techniques of the corresponding user; and
create learning pathways for the corresponding user based on the personalized learning profile, wherein the learning pathways include details associated with at least one of: a complexity, a format, and a presentation of the content to be presented on the corresponding user device; and
an optimization server communicatively coupled to the personalization server, the optimization server including:
a plurality of artificial intelligent agent teacher modules correspondingly associated with a plurality of education disciplines, wherein each artificial intelligent agent teacher module is configured to:
receive the learning pathways associated with the corresponding user of each user device from the corresponding artificial intelligence module; and
generate the content associated with the corresponding education discipline correspondingly for each user device based on the received learning pathways;
wherein each artificial intelligence module is further configured to:
determine performance data and interaction data associated with the corresponding user based on the content presented on the corresponding user device in real-time;
adapt learning pathways for the corresponding user based on the performance data and the interaction data of the corresponding user with the content presented on the corresponding user device, wherein adapting the learning pathways includes adjustments to the at least one of: the complexity, the format, and the presentation of the content to be presented on the corresponding user device;
repeat determination of the performance data and the interaction data, and the adaptation of the learning pathways for the corresponding user when new performance data and interaction data is determined; and
anonymize and transmit the personal data, the education data, the interaction data, and the performance data of the corresponding user for storage to a storage server; and
wherein each artificial intelligent agent teacher module is further configured to:
receive the adapted learning pathways associated with the corresponding user of each user device from the corresponding artificial intelligence module;
update the content associated with the corresponding education discipline correspondingly for each user device based on the received adapted learning pathways;
continuously retrieve and analyze the personal data, the education data, the interaction data, and the performance data associated with the plurality of user devices stored in the storage server to refine one or more grading algorithms, assessments, and teaching methods; and
continuously adapt the content to be presented correspondingly on each user device based on the refined one or more grading algorithms, assessments, and teaching methods.

2. The system of claim 1, further including:
the storage server configured to:
securely store the anonymized personal data, the anonymized education data, the anonymized interaction data, and the anonymized performance data for each of the plurality of user devices;
associate the anonymized personal data, the anonymized education data, the anonymized interaction data, and the anonymized performance data for each user with a designated identity; and
provide the corresponding user with control permissions associated with the designated identity.

3. The system of claim 1, wherein the plurality of user devices are correspondingly coupled to a plurality of sensor units, each sensor unit including one or more of a camera, a microphone, a smartwatch, or an internet-of-things device, wherein each sensor unit is configured to:
capture the interaction data of the corresponding user with the content presented on the corresponding user device, wherein the interaction data includes one or more of facial expressions, voice, tone, and physiological data of the user.

4. The system of claim 3, wherein the personalization server further includes an emotion detection subsystem comprising one or more machine learning models configured to:
determine an emotional state of the corresponding user based on the interaction data; and
wherein adapting the learning pathways includes adapting the learning pathways based on the performance data and the emotional state of the corresponding user.

5. The system of claim 1, wherein the plurality of user devices are correspondingly coupled to a plurality of auxiliary devices, each auxiliary device including one or more of an augmented reality device, a virtual reality device, gloves, or a wearable device, wherein each auxiliary device is configured to:
establish a sensory engagement of the content with the corresponding user.

6. The system of claim 1, wherein each of the plurality of artificial intelligent teacher modules are configured to generate the content by:
obtaining, via one or more application programming interface (API), data associated with the corresponding education disciplines from one or more large language models (LLM); and
modifying the obtained data based on the learning pathways and the adapted learning pathways associated with the corresponding user to generate the content personalized for the user.

7. The system of claim 4, wherein the personalization server further includes a generative artificial intelligence module configured to:
generate a three-dimensional (3D) persona to deliver the content on the corresponding user device; and
modify interactions of the 3D persona with the corresponding user on the corresponding user device based on the emotional state of the user.

8. The system of claim 1, wherein the personal data includes data associated with the region and language of the corresponding user, and further wherein generating the content associated with the corresponding education discipline includes modifying the content based on the data associated with the region and language of the corresponding user.

9. The system of claim 1, wherein the optimization server further includes a curriculum management module configured to:
dynamically update the content associated with a curriculum based on changes in educational standards and regulations of the curriculum.

10. The system of claim 1, wherein each artificial intelligence module is further configured to:
maintain, for its corresponding user device, an anonymous user specific parameter set comprising one or more of fine-tuned model weights, delta layers, adapter layers, Low-Rank Adaptation (LoRA) adapters, and personalized embeddings; and
utilize the user specific parameter set together with a set of parameters common to other users when generating the personalized learning profile and the learning pathways.

11. The system of claim 1, wherein each artificial intelligence module is configured to adapt the learning pathways based on at least one of (a) scheduling constraints of the corresponding user device and (b) environmental-context data representative of one or more of lighting, noise, and ambient conditions along with external environmental factors.

12. The system of claim 1, wherein the personalization server is further configured to:
receive, in real time or periodically, the anonymized personal data, the anonymized education data, the anonymized interaction data, and the anonymized performance data from the storage server; and
adapt the learning pathways based on the anonymized personal data, the anonymized education data, the anonymized interaction data, and the anonymized performance data;
wherein the optimization server is further configured to receive updates to the learning pathways or the adapted learning pathways to continuously adapt the content and refine the one or more grading algorithms, assessments, and teaching methods.

13. The system of claim 10, wherein each user device is further configured to train a local artificial-intelligence model using the user-specific parameter set and transmit anonymized gradient or delta parameters to the personalization server, thereby implementing a federated-learning process that preserves user privacy.

14. The system of claim 1, wherein each artificial intelligent agent teacher module is configured to generate the content by accessing one or more remote artificial intelligent models using an application programming interface (API) or a communication gateway.

15. A method for continuously adapting a content on an education platform, the method comprising:
obtaining, by each user device of a plurality of user devices, data associated with a corresponding user, wherein the data includes personal data and education data of the corresponding user;
obtaining, by each artificial intelligence module of a plurality of artificial intelligence modules of a personalization server, the personal data and the education data associated with the corresponding user from the corresponding user device;
creating, by each artificial intelligence module, a personalized learning profile for the corresponding user based on the personal data and the education data, wherein the personalized learning profile includes data associated with one or more of learning capabilities, learning disabilities, education preferences, preferred learning techniques of the corresponding user;
creating, by each artificial intelligence module, learning pathways for the corresponding user based on the personalized learning profile, wherein the learning pathways include details associated with at least one of: a complexity, a format, and a presentation of the content to be presented on the corresponding user device;
receiving, by each artificial intelligent agent teacher module of a plurality of artificial intelligent agent teacher modules of an optimization server, the learning pathways associated with the corresponding user of each user device from the corresponding artificial intelligence module; and
generating, by each artificial intelligent agent teacher module, the content associated with the corresponding education discipline correspondingly for each user device based on the received learning pathways;
determining, by each artificial intelligence module, performance data and interaction data associated with the corresponding user based on the content presented on the corresponding user device in real-time;
adapting, by each artificial intelligence module, learning pathways for the corresponding user based on the performance data and the interaction data of the corresponding user with the content presented on the corresponding user device, wherein adapting the learning pathways includes adjustments to the at least one of: the complexity, the format, and the presentation of the content to be presented on the corresponding user device;
repeating, by each artificial intelligence module, determination of the performance data and the interaction data, and the adaptation of the learning pathways for the corresponding user when new performance data and interaction data is determined;
anonymizing and transmitting, by artificial intelligence module, the personal data, the education data, the interaction data, and the performance data of the corresponding user for storage to a storage server;
receiving, by each artificial intelligent agent teacher module, the adapted learning pathways associated with the corresponding user of each user device from the corresponding artificial intelligence module;
updating, by each artificial intelligent agent teacher module, the content associated with the corresponding education discipline correspondingly for each user device based on the received adapted learning pathways;
continuously retrieving and analyzing, by each artificial intelligent agent teacher module, the personal data, the education data, the interaction data, and the performance data associated with the plurality of user devices stored in the storage server to refine one or more grading algorithms, assessments, and teaching methods; and
continuously adapting, by each artificial intelligent agent teacher module, the content to be presented correspondingly on each user device based on the refined one or more grading algorithms, assessments, and teaching methods.

16. The method of claim 15, further including:
securely storing, by the storage server, the anonymized personal data, the anonymized education data, the anonymized interaction data, and the anonymized performance data for each of the plurality of user devices;
associating, by the storage server, the anonymized personal data, the anonymized education data, the anonymized interaction data, and the anonymized performance data for each user with a designated identity; and
providing, by the storage server, the corresponding user with control permissions associated with the designated identity.

17. The method of claim 15, wherein the plurality of user devices are correspondingly coupled to a plurality of sensor units, each sensor unit including one or more of a camera, a microphone, a smartwatch, or an internet-of-things device, the method further including:
capturing, by each sensor unit, the interaction data of the corresponding user with the content presented on the corresponding user device, wherein the interaction data includes one or more of facial expressions, voice, tone, and physiological data of the user.

18. The method of claim 17, further including:
determining, by one or more machine learning module of an emotion detection subsystem of the personalization server, an emotional state of the corresponding user based on the interaction data; and
wherein adapting the learning pathways includes adapting the learning pathways based on the performance data and the emotional state of the corresponding user.

19. The method of claim 15, wherein the plurality of user devices are correspondingly coupled to a plurality of auxiliary devices, each auxiliary device including one or more of an augmented reality device, a virtual reality device, gloves, or a wearable device, the method further including:
establishing, by each auxiliary device, a sensory engagement of the content with the corresponding user.

20. The method of claim 15, wherein generating the content includes:
obtaining, by each artificial intelligent agent teacher module, via one or more application programming interface (API), data associated with the corresponding education disciplines from one or more large language models (LLM); and
modifying, by each artificial intelligent agent teacher module, the obtained data based on the learning pathways and the adapted learning pathways associated with the corresponding user to generate the content personalized for the user.

21. The method of claim 18, further including:
generating, by a generative artificial intelligence module of the personalization server, a three-dimensional (3D) persona to deliver the content on the corresponding user device; and
modifying, by the generative artificial intelligence module, interactions of the 3D persona with the corresponding user on the corresponding user device based on the emotional state of the user.

22. The method of claim 15, wherein the personal data includes data associated with the region and language of the corresponding user, and further wherein generating the content associated with the corresponding education discipline includes modifying the content based on the data associated with the region and language of the corresponding user.

23. The method of claim 15, the method includes:
dynamically updating, by a curriculum management module of the optimization server, the content associated with a curriculum based on changes in educational standards and regulations of the curriculum.
